(19) United States
(12) Patent Application Publication
(10) Pub. No.: US 2001/0034686 A1
(43) Pub. Date: Oct. 25, 2001

(54) Method of and system for defining and measuring the real options of a commercial enterprise

(76) Inventor: Jeff Scott Eder, Mill Creek, WA (US)

Correspondence Address: Jeff Eder, 19108 30th Drive SE, Mill Creek, WA, 98012, US

(21) Appl. No.: 09/764,068

(22) Filed: Jan. 19, 2001

Related U.S. Application Data
(63) Continuation-in-part of application No. 08/999,245, filed on Dec. 10, 1997.
(63) Continuation-in-part of application No. 09/358,969, filed on Jul. 22, 1999.

(51) Int. Cl. G06F 17/60

(52) U.S. Cl. 705/36; 705/7

(57) ABSTRACT

An automated system (100) and method for defining and measuring the real options of a commercial enterprise on a specified valuation date. The real options are evaluated on the basis of the relative strength of the elements of value of the enterprise. The performance of the elements of value are first summarized using composite variables. The elements of value that cause change in enterprise stock price are then determined. The relative strength of the causal elements of value for the enterprise vis a vis its competitors are then calculated. The relative ranking of the enterprise causal elements of value is then used in determining the discount rate to be used in real option valuation. The real options are then valued using Black Scholes algorithm.

### BACKGROUND OF THE INVENTION

This invention relates to a method of and system for business valuation, more particularly, to an automated system that defines and measures the elements of value and uses those measurements to calculate the value of the real options of a commercial enterprise on a specified date.

The internet has had many profound effects on commerce in America and the world. The dramatic increase in the use of email, the explosion of e-commerce and the meteoric rise in the market value of internet firms like E Bay, Amazon.com and Yahoo! are some of the more visible examples of the impact it has had on the American economy. One of the least publicized impacts of the internet revolution is that it has led many to search for a new method for systematically evaluating the value of commercial businesses. This search is being motivated by the multi-billion dollar valuations being placed on internet companies like Amazon.com, Yahoo and E-Bay that have never earned a dollar of profit. Even worse, from the traditional point of view, these companies have no prospect of earning a dollar of profit any time soon. The most popular traditional approaches to valuation are all based on some multiple of accounting earnings (a price to earnings ratio or P/E ratio)—with no earnings in the past or the foreseeable future—these methods are of course useless.

The inability of traditional methods to provide a framework for analyzing the continued rise in the market valuations for internet firms is just one example of the weakness of traditional financial systems. Numerous academic studies have demonstrated that accounting earnings don't fully explain changes in company valuations and the movement of stock prices. Many feel that because of this traditional accounting systems are driving information-age managers to make the wrong decisions and the wrong investments. Accounting systems are “wrong” for one simple reason, they track tangible assets while ignoring intangible assets. Intangible assets such as the skills of the workers, intellectual property, business infrastructure, databases, and relationships with customers and suppliers are not measured with current accounting systems. This oversight is critical because in the present economy the success of an enterprise is determined more by its ability to use its intangible assets than by its ability to amass and control the physical ones that are tracked by traditional accounting systems.

The relatively recent experience of several of the most important companies in the U.S. economy, IBM, General Motors and DEC, illustrates the problems that can arise when intangible asset information is omitted from corporate financial statements. All three were showing large profits using current accounting systems while their businesses were deteriorating. If they had been forced to take write-offs when the declines in intangible assets were occurring, the problems would have been visible to the market and management would have been forced to act to correct the problems much more quickly than they actually did. These deficiencies of traditional accounting systems are particularly noticeable in high technology companies that are highly valued for their intangible assets and their options to enter growing markets rather than their tangible assets.

The accounting profession itself recognizes the limitations of traditional accounting systems. A group of senior financial executives, educators and consultants that had been asked to map the future of financial management by the American Institute of Certified Public Accountants (AICPA) recently concluded that: operating managers will continue to lose confidence in traditional financial reporting systems and that the traditional financial report will never again be used as the exclusive basis for any business decisions. The deficiency of traditional accounting systems causes enormous distortions in the behavior of many American firms. Because traditional accounting methods ignore intangible assets, expenditures that develop a market or expand the capabilities of an organization are generally shown as expenses that only decrease the current period profit. For example, an expenditure for technical training which increases the value of an employee to an enterprise is an expense while an expenditure to refurbish a piece of furniture which does nothing to increase sales or improve profitability is capitalized as an asset.

A number of people have suggested using business valuations in place of traditional financial statements as the basis for measuring financial performance. Unfortunately, using current methods, the valuation of a business is a complex and time-consuming undertaking. Business valuations determine the price that a hypothetical buyer would pay for a business under a given set of circumstances. The volume of business valuations being performed each year is increasing significantly. A leading cause of this growth in volume is the increasing use of mergers and acquisitions as vehicles for corporate growth. Business valuations are frequently used in setting the price for a business that is being bought or sold. Another reason for the growth in the volume of business valuations has been their increasing use in areas other than supporting merger and acquisition transactions. For example, business valuations are now being used by financial institutions to determine the amount of credit that should be extended to a company, by courts in determining litigation settlement amounts and by investors in evaluating the performance of company management.

In most cases, a business valuation is completed by an appraiser or a Certified Public Accountant (hereinafter, appraiser) using a combination of judgment, experience and an understanding of generally accepted valuation principles. The two primary types of business valuations that are widely used and accepted are income valuations and asset valuations. Market valuations are also used in some cases but their use is restricted because of the difficulty inherent in trying to compare two different companies.

Income valuations are based on the premise that the current value of a business is a function of the future value that an investor can expect to receive from purchasing all or part of the business. Income valuations are the most widely used type of valuation. In these valuations the expected returns from investing in the business and the risks associated with receiving the expected returns are evaluated by the appraiser. The appraiser then determines the value whereby a hypothetical buyer would receive a sufficient return on the investment to compensate the buyer for the risk associated with receiving the expected returns. One difficulty with this method is determining the length of time the company is expected to generate the expected returns that drive the valuation. Most income valuations use an explicit forecast of returns for some period, usually 3 to 5 years, combined with a “residual”. The residual is generally a flat or uniformly growing forecast of future returns that is discounted by some factor to estimate its value on the date of valuation. In some cases the residual is the largest part of the calculated value.

One of the problems inherent in a steady state “residual” forecast is that returns don't continue forever. Economists generally speak of a competitive advantage period or CAP (hereinafter referred to as CAP) during which a given firm is expected to generate positive returns. Under this theory, value is generated only during the CAP after which time value creation goes to zero or turns negative. Another change that has been produced by the internet economy is that the CAP for most businesses is generally thought to be shrinking with the exception of companies whose products possess network externalities that tie others to the company and its products or services. These latter companies are thought to experience increasing returns as time goes by rather than having a finite CAP. Because the CAP is hard to calculate, it is generally ignored in income valuations however, the simplification of ignoring the CAP greatly reduces the utility of the valuations that are created with large residuals.

Asset valuations don't have the problem with residuals because they consider the business to be a collection of assets which have an intrinsic value to a third party. Asset valuations are typically used for businesses that are ceasing operation and for specific type of businesses such as holding companies and investment companies. Asset valuation methods include the book value method, the adjusted book value method, the economic balance sheet method and the liquidation method. As discussed previously, market valuations are used to place a value on one business by using ratios that have been established for comparable businesses in either a public stock market or a recent transaction. The most popular market valuation method is the PIE (price to earnings) ratio.

When performing a business valuation, the appraiser is generally free to select the valuation type and method (or some combination of the methods) in determining the business value. The usefulness of these valuations is limited because there is no correct answer, there is only the best possible informed guess for any given business valuation. The usefulness of business valuations to business owners and managers is restricted for another reason—valuations typically determine only the value of the business as a whole. To provide information that would be useful in improving the business, the valuation would have to furnish supporting detail that would highlight the value of different elements of the business. An operating manager would then be able to use a series of business valuations to identify elements within a business that have been decreasing in value. This information could also be used to help identify corrective action programs and to track the progress that these programs have made in increasing business value. This same information could also be used to identify elements that are contributing to an increase in business value. This information could be used to identify elements where increased levels of investment would have a significant favorable impact on the overall health of the business.

Even when intangible assets have been considered, the limitations in the existing methodology have severely restricted the utility of the valuations that have been produced. All known prior efforts to value intangible assets have been restricted to independent valuations of different types of intangible assets. Intangible assets that have been valued separately in this fashion include: brand names, customers and intellectual property. Problems associated with existing methods for valuing intangible assets include: interactions between intangible assets are ignored, the actual impact of the asset on the enterprise isn't measured and there is no systematic way for determining the life of the asset.

Along the same lines, these valuations also typically ignore real options for growth. Even when the real options are analyzed, the valuations do not account for the fact that the value of the real options is a function of the elements of value that support the realization of the real option. For example, the value of an option to develop an oil field is more valuable to Exxon/Mobil than it is to General Motors. Both companies have the money required to develop the field but only Exxon/Mobil has the tangible and intangible elements of value like a distribution network, processing knowledge and refinery equipment that will readily transform the option in to a tangible cash flow. In a similar fashion, many of the “dot-com” companies have discovered too late that the elements of value that support the operation of bricks and mortar stores are vital elements in creating a profitable business out of the option to develop an on-line storefront.

Contingent liabilities, which are liabilities that might occur, are also typically ignored. Their analysis and valuation parallels the analysis and valuation of real options.

The lack of a consistent, well accepted, realistic method for measuring real options and all the elements of business value also prevents some firms from receiving the financing they need to grow. Most banks and lending institutions focus on book value when evaluating the credit worthiness of a business seeking funds. As stated previously, the value of many high technology firms lies primarily in intangible assets and growth options that aren't visible under traditional definitions of accounting book value. As a result, these businesses generally aren't eligible to receive capital from traditional lending sources, even though their financial prospects are generally far superior to those of companies with much higher tangible book values.

In light of the preceding discussion, it is clear that it would be advantageous to have an automated financial system that valued all the assets, real options and contingent liabilities for a given enterprise. Ideally, this system would be capable of generating detailed valuations for businesses in new industries.

### SUMMARY OF THE INVENTION

It is a general object of the present invention to provide a novel and useful system that calculates and displays a comprehensive and accurate valuation for the real options and contingent liabilities of an enterprise that overcomes the limitations and drawbacks of the prior art that were described previously.

A preferable object to which the present invention is applied is the valuation of the real options of an internet commerce company where a significant portion of the business value is associated with options for growth. While the discussion that follows will center on real option valuation. The identical procedure can be used for contingent liability analysis.

The present invention also eliminates a great deal of time-consuming and expensive effort by automating the extraction of data from the databases, tables, and files of existing computer-based corporate finance, operations, human resource, supply chain, web-site and “soft” asset management system databases as required to operate the system. In accordance with the invention, the automated extraction, aggregation and analysis of data from a variety of existing computer-based systems significantly increases the scale and scope of the analysis that can be completed. The system of the present invention further enhances the efficiency and effectiveness of the business valuation by automating the retrieval, storage and analysis of information useful for valuing elements of value from external databases, publications and the internet. Uncertainty over which method is being used for completing the valuation and the resulting inability to compare different valuations is eliminated by the present invention by consistently utilizing the same set of valuation methodologies for valuing the different segments of enterprise value as shown in Table 1.

TABLE 1

| Segment of Enterprise Value | | Valuation methodology |
|---|---|---|
| Excess Cash & Marketable Securities | | Calculated value |
| Market Sentiment | | Market Value* - |
| | | (COPTOT + ΣReal |
| | | Option Values) |
| Total Current-Operation Value (COPTOT): | | Income Valuation |
| Financial Assets: Cash & Marketable Securities | | GAAP |
| (CASH) | | |
| Financial Assets: Accounts Receivable (AR) | | GAAP |
| Financial Assets: Inventory (IN) | | GAAP |
| Financial Assets: Prepaid Expenses (PE) | | GAAP |
| Financial Assets: Other Assets (OA) | | Lower of GAAP or |
| | | liquidation value |
| Elements of Production Equipment (PEQ) | | If calculated value > |
| Value: | | liquidation value, then |
| | | use system calculated |
| | | value, else use liquida- |
| | | tion value |
| Elements of Intangible Elements (IE): | | |
| Value: | Customers | System calculated value |
| | Employees | System calculated value |
| | Vendor Relationships | System calculated value |
| | Strategic Partnerships | System calculated value |
| | Brand Names | System calculated value |
| | Other Intangibles | System calculated value |

| | |
|---|---|
| Elements of General Going Concern | GCV = COPTOT- |
| Value: Value (GCV) | CASH-AR-IN-PE-PEQ- |
| | OA-IE |
| Real options | Real option algorithms |

*The user also has the option of specifying the total value

The market value of the enterprise is calculated by combining the market value of all debt and equity as shown in Table 2.

TABLE 2

Enterprise Market Value =
ΣMarket value of enterprise equity −
ΣMarket value of company debt

Consultants from McKinsey & Company recently completed a three year study of companies in 10 industry segments in 12 countries that confirmed the importance of intangible elements of value as enablers of new business expansion and profitable growth. The results of the study, published in the book The Alchemy of Growth, revealed three common characteristics of the most successful businesses in today's economy:

1. They consistently utilize “soft” or intangible assets like brands, customers and employees to support business expansion;

2. They systematically generate and harvest real options for growth; and

3. Their management focuses on 3 distinct “horizons”—short term (1-3 years), growth (3-5 years out) and options (beyond 5 years).

The experience of several of the most important companies in the U.S. economy, e.g. IBM, General Motors and DEC, in the late 1980s and early 1990s illustrates the problems that can arise when intangible asset information is omitted from corporate financial statements and companies focus only on the short term horizon. All three companies were showing large profits using current accounting systems while their businesses were deteriorating. If they had been forced to take write-offs when the declines in intangible assets were occurring, the problems would have been visible to the market and management would have been forced to act to correct the problems much more quickly than they actually did. These deficiencies of traditional accounting systems are particularly noticeable in high technology companies that are highly valued for their intangible assets and their options to enter growing markets rather than their tangible assets.

One benefit of the novel system is that the market value of the enterprise is subdivided in to three distinct categories of value: financial assets, elements of value and real options. As shown in Table 3, these three value categories correspond to the three distinct “horizons” for management focus the McKinsey consultants reported on in The Alchemy of Growth.

TABLE 3

| System Value Categories | Three Horizons |
|---|---|
| Financial Assets | Short Term |
| Elements of Value | Growth |
| Real Options | Options |

The utility of the valuations produced by the system of the present invention are further enhanced by explicitly calculating the impact of the tangible and intangible elements of value on the real options being analyzed.

As shown in Tables 1, real options are valued using real option algorithms. Because real option algorithms explicitly recognize whether or not an investment is reversible and/or if it can be delayed, the values calculated using these algorithms are more realistic than valuations created using more traditional approaches like Net Present Value. The use of real option analysis for valuing growth opportunities and contingent liabilities (hereinafter, real options) gives the present invention a distinct advantage over traditional approaches to business valuation.

The innovative system has the added benefit of providing a large amount of detailed information concerning both tangible and intangible elements of value. Because intangible elements are by definition not tangible, they can not be measured directly. They must instead be measured by the impact they have on their surrounding environment. There are analogies in the physical world. For example, electricity is an “intangible” that is measured by the impact it has on the surrounding environment. Specifically, the strength of the magnetic field generated by the flow of electricity through a conductor is used to determine the amount of electricity that is being consumed. The system of the present invention measures intangible elements of value by identifying the attributes that, like the magnetic field, reflect the strength of the element in driving components of value (revenue, expense and change in capital) and market prices for company equity and are easy to measure. Once the attributes related to the strength of each element are identified, they can be summarized into a single expression (a composite variable or vector). The vectors for all elements are then evaluated to determine their relative contribution to driving each of the components of value. The system of the present invention calculates the product of the relative contribution of each element and forecast life to determine the contribution to each of the components of value. The contributions to each component of value are then added together to determine the value of each element (see Table 5).

The system also gives the user the ability to track the changes in the value of the customer and supplier bases by comparing the current valuations to previously calculated valuations. As such, the system provides the user with a long term measure of the effectiveness of customer acquisition and retention programs. To facilitate its use as a tool for improving the value of a commercial enterprise, the system of the present invention produces reports in formats that are similar to the reports provided by traditional accounting systems. The method for tracking the elements of value for a business enterprise provided by the present invention eliminates many of the limitations associated with current systems for managing an interactive sales process that were described previously.

### BRIEF DESCRIPTION OF DRAWINGS

These and other objects, features and advantages of the present invention will be more readily apparent from the following description of the preferred embodiment of the invention in which:

FIG. 1 is a block diagram showing the major processing steps of the present invention;

FIG. 2 is a diagram showing the files or tables in the application database of the present invention that are utilized for data storage and retrieval during the processing that improves the performance of an interactive sales process;

FIG. 3 is a block diagram of an implementation of the present invention;

FIG. 4 is a diagram showing the data windows that are used for receiving information from and transmitting information to the user (20) during system processing;

FIG. 5A, FIG. 5B, FIG. 5C, FIG. 5D, FIG. 5E and FIG. 5F are block diagrams showing the sequence of steps in the present invention used for specifying system settings and for initializing and operating the data bots that extract, aggregate, store and manipulate information utilized in system processing from: user input, the basic financial system database, the operation management system database, the web site transaction log database, the human resource information system database, the external database, the advanced financial system database, the soft asset management system databases, the supply chain system database and the internet;

FIG. 6A, FIG. 6B and FIG. 6C are block diagrams showing the sequence of steps in the present invention that are utilized for initializing and operating the analysis bots;

FIG. 7 is a block diagram showing the sequence of steps in the present invention used for producing management reports

### DETAILED DESCRIPTION OF THE PREFERRED EMBODIMENT

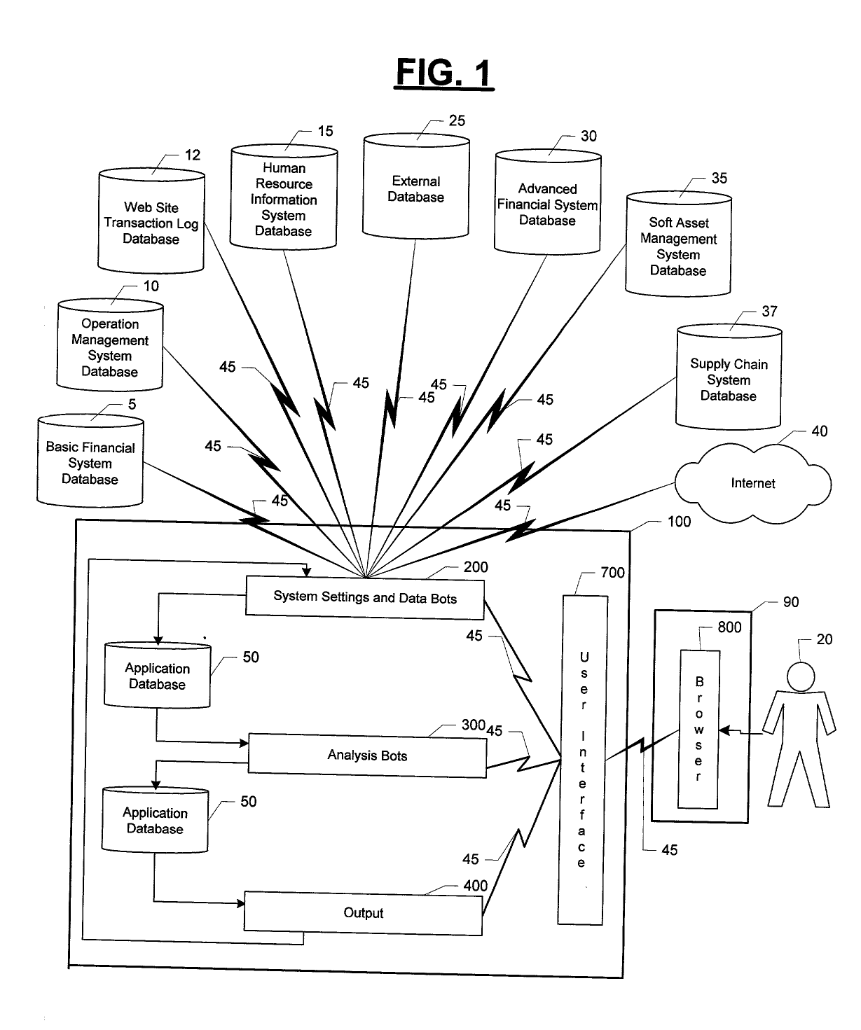

FIG. 1 provides an overview of the processing completed by the innovative system for defining and measuring the elements of value and real options of a commercial enterprise. In accordance with the present invention, an automated method of and system (100) for business valuation, activity analysis and promotion coordination is provided. Processing starts in this system (100) with the specification of system settings and the initialization and activation of software data “bots” (200) that extract, aggregate, manipulate and store the data and user (20) input required for completing system processing. This information is extracted via a network (45) from: a basic financial system database (5), an operation management system database (10), a web site transaction log database (12), a human resource information system database (15), an external database (25), an advanced financial system database (30), a soft asset management system database (35), a supply chain system database (37) and the internet (40). These information extractions and aggregations may be influenced by a user (20) through interaction with a user-interface portion of the application software (700) that mediates the display, transmission and receipt of all information to and from a browser (800) such as Microsoft Internet Explorer in an access device (90) such as a phone or personal computer that the user (20) interacts with. While only one database of each type (5, 10, 12, 15, 25, 30, 35 and 37) is shown in FIG. 1, it is to be understood that the system (100) can extract data from multiple databases of each type via the network (45). The preferred embodiment of the present invention contains a soft asset management system for each element of value being analyzed. Automating the extraction and analysis of data from each soft asset management system ensures that each soft asset is considered within the overall financial models for the enterprise. It should also be understood that it is possible to complete a bulk extraction of data from each database (5, 10, 12, 15, 25, 30, 35 and 37) via the network (45) using data extraction applications such as Data Transformation Services from Microsoft or Aclue from Decisionism before initializing the data bots. The data extracted in bulk could be stored in a single datamart or data warehouse where the data bots could operate on the aggregated data.

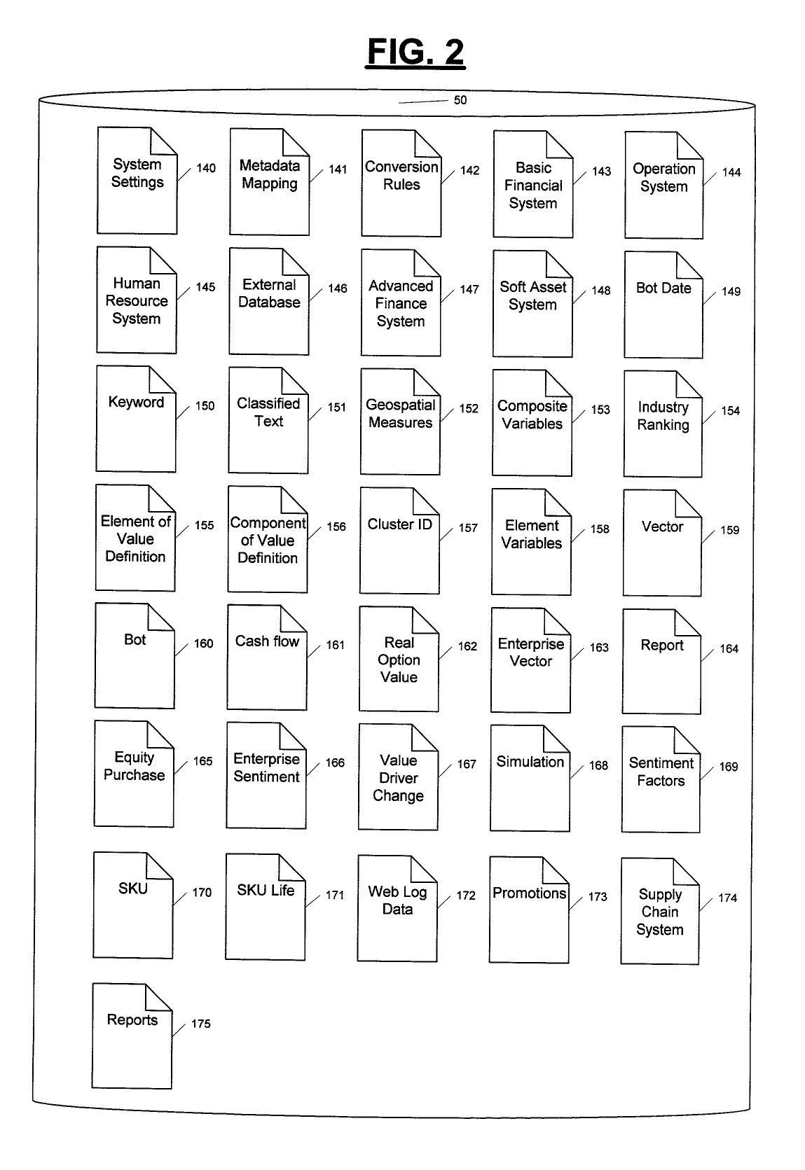

All extracted information is stored in a file or table (hereinafter, table) within an application database (50) as shown in FIG. 2. The application database (50) contains tables for storing user input, extracted information and system calculations including a: system settings table (140), a metadata mapping table (141), a conversion rules table (142), a basic financial system table (143), an operation system table (144), a human resource system table (145), an external database table (146), an advanced finance system table (147), a soft asset system table (148), a bot date table (149), a keyword table (150), a classified text table (151), a geospatial measures table (152), a composite variables table (153), an industry ranking table (154), an element of value definition table (155), a component of value definition table (156), a cluster ID table (157), an element variables table (158), a vector table (159), a bot table (160), a cash flow table (161), a real option value table (162), an enterprise vector table (163), a report table (164), an equity purchase table (165), an enterprise sentiment table (166), a value driver change table (167), a simulation table (168), a sentiment factors table (169), an SKU table (170), an SKU life table (171), a web log data table (172), a promotions table (173), a supply chain system table (174) and a reports table (175). The application database (50) can optionally exist as a datamart, data warehouse or departmental warehouse. The system of the present invention has the ability to accept and store supplemental or primary data directly from user input, a data warehouse or other electronic files in addition to receiving data from the databases described previously. The system of the present invention also has the ability to complete the necessary calculations without receiving data from one or more of the specified databases. However, in the preferred embodiment all required information is obtained from the specified data sources (5, 10, 12, 15, 25, 30, 35, 37 and 40).

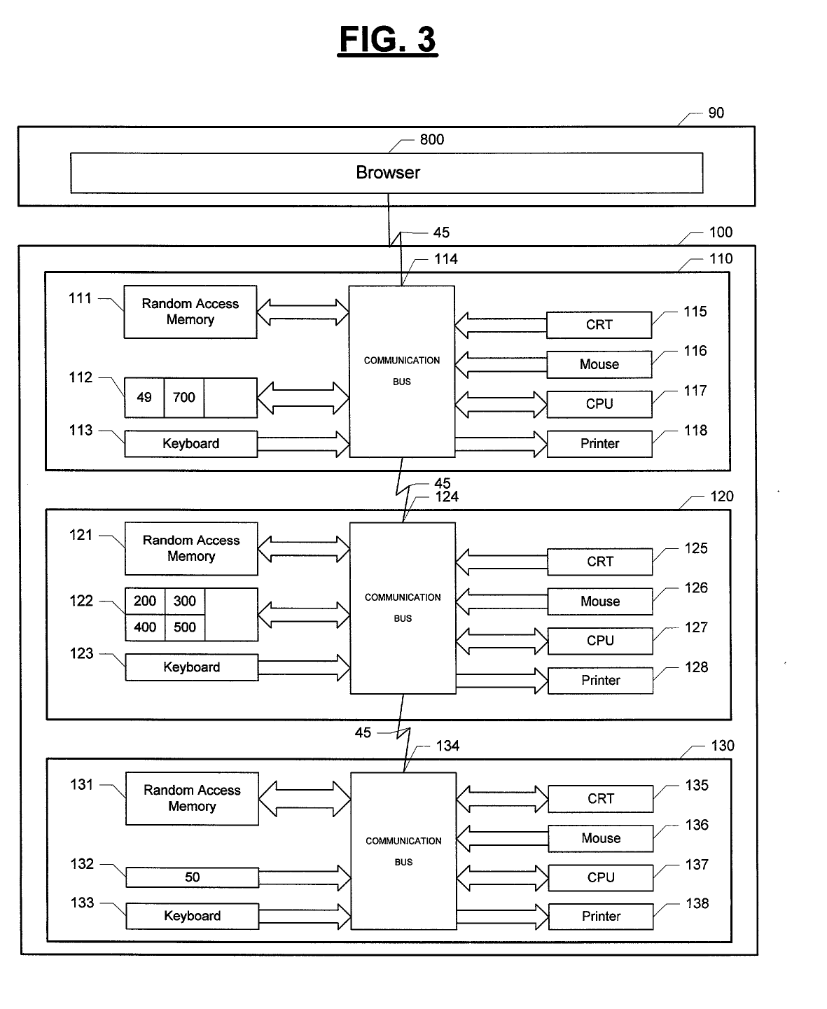

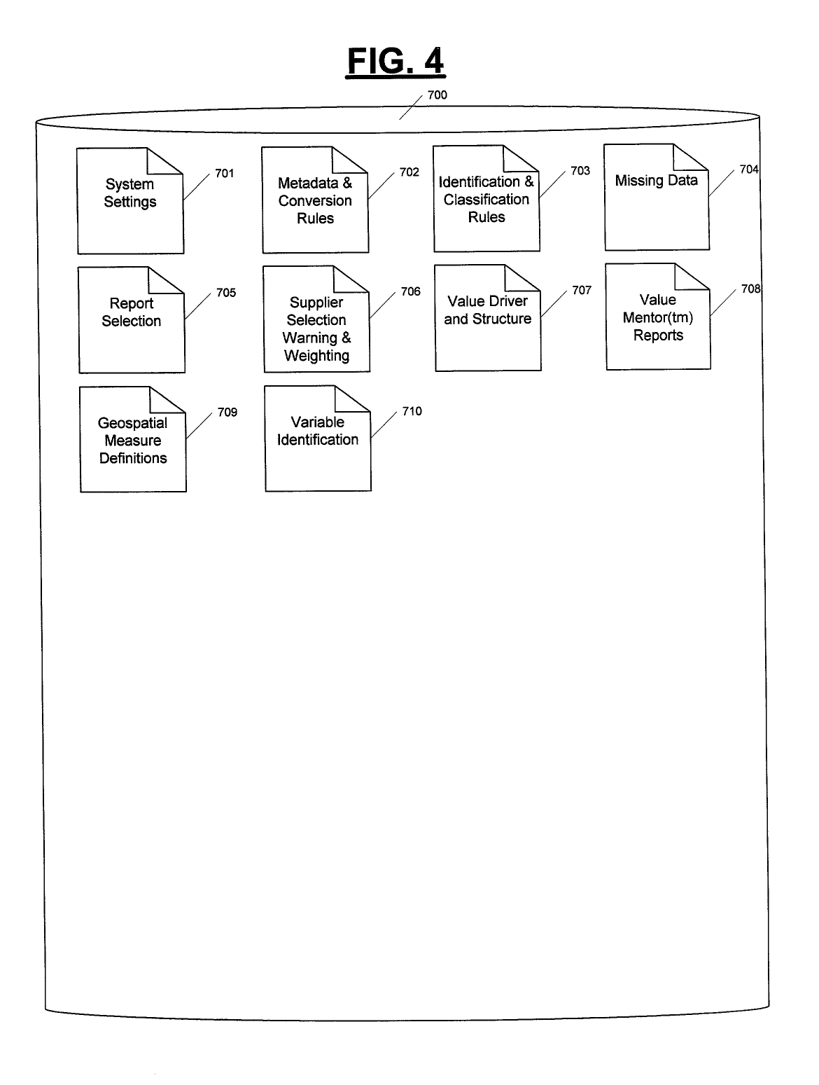

As shown in FIG. 3, the preferred embodiment of the present invention is a computer system (100) illustratively comprised of a user-interface personal computer (110) connected to an application server personal computer (120) via a network (45). The application server personal computer (120) is in turn connected via the network (45) to a database-server personal computer (130). The user interface personal computer (110) is also connected via the network (45) to an internet browser appliance (90) that contains browser software (800) such as Microsoft Internet Explorer or Netscape Navigator.

The database-server personal computer (130) has a read/write random access memory (131), a hard drive (132) for storage of the application database (50), a keyboard (133), a communication bus (134), a CRT display (135), a mouse (136), a CPU (137) and a printer (138).

The application-server personal computer (120) has a read/write random access memory (121), a hard drive (122) for storage of the non-user interface portion of the application software (200, 300 and 400) of the present invention, a keyboard (123), a communication bus (124), a CRT display (125), a mouse (126), a CPU (127) and a printer (128). While only one client personal computer is shown in FIG. 3, it is to be understood that the application-server personal computer (120) can be networked to fifty or more client personal computers (110) via the network (45). The application-server personal computer (120) can also be networked to fifty or more server personal computers (130) via the network (45). It is to be understood that the diagram of FIG. 3 is merely illustrative of one embodiment of the present invention.

The user-interface personal computer (110) has a read/write random access memory (111), a hard drive (112) for storage of a client data-base (49) and the user-interface portion of the application software (700), a keyboard (113), a communication bus (114), a CRT display (115), a mouse (116), a CPU (117) and a printer (118).

The application software (200, 300, 400 and 700) controls the performance of the central processing unit (127) as it completes the calculations required to complete the detailed business valuation, activity analysis and promotion coordination. In the embodiment illustrated herein, the application software program (200, 300, 400 and 700) is written in a combination of C++ and Visual Basic®. The application software (200, 300, 400 and 700) can use Structured Query Language (SQL) for extracting data from the databases and the internet (5, 10, 12, 15, 25, 30, 35, 37 and 40). The user (20) can optionally interact with the user-interface portion of the application software (700) using the browser software (800) in the browser appliance (90) to provide information to the application software (200, 300, 400 and 700) for use in determining which data will be extracted and transferred to the application database (50) by the data bots.

User input is initially saved to the client database (49) before being transmitted to the communication bus (124) and on to the hard drive (122) of the application-server computer via the network (45). Following the program instructions of the application software, the central processing unit (127) accesses the extracted data and user input by retrieving it from the hard drive (122) using the random access memory (121) as computation workspace in a manner that is well known.

The computers (110, 120 and 130) shown in FIG. 3 illustratively are IBM PCs or clones or any of the more powerful computers or workstations that are widely available. Typical memory configurations for client personal computers (110) used with the present invention should include at least 512 megabytes of semiconductor random access memory (111) and at least a 100 gigabyte hard drive (112). Typical memory configurations for the application-server personal computer (120) used with the present invention should include at least 2056 megabytes of semiconductor random access memory (121) and at least a 250 gigabyte hard drive (122). Typical memory configurations for the database-server personal computer (130) used with the present invention should include at least 4112 megabytes of semiconductor random access memory (135) and at least a 500 gigabyte hard drive (131).

Using the system described above, customer activity is analyzed, targeted promotions are developed and checked against supply chain availability and each element of value within the enterprise is analyzed as shown in Table 1. As shown in Table 1, the value of the current-operation will be calculated using an income valuation. An integral part of most income valuation models is the calculation of the present value of the expected cash flows, income or profits associated with the current-operation. The present value of a stream of cash flows is calculated by discounting the cash flows at a rate that reflects the risk associated with realizing the cash flow. For example, the present value (PV) of a cash flow of ten dollars ($10) per year for five (5) years would vary depending on the rate used for discounting future cash flows as shown below.

Discount rate = 25%
$PV = \frac{10}{1.25} + \frac{10}{{( 1.25 )}^{2}} + \frac{10}{{( 1.25 )}^{3}} + \frac{10}{{( 1.25 )}^{4}} + \frac{10}{{( 1.25 )}^{5}} = 26.89$
Discount rate = 35%
$PV = \frac{10}{1.35} + \frac{10}{{( 1.35 )}^{2}} + \frac{10}{{( 1.35 )}^{3}} + \frac{10}{{( 1.35 )}^{4}} + \frac{10}{{( 1.35 )}^{5}} = 22.20$

One of the first steps in evaluating the elements of current-operation value is extracting the data required to complete calculations in accordance with the formula that defines the value of the current-operation as shown in Table 4.

TABLE 4

Value of current-operation =
(R) Value of forecast revenue from current-operation (positive) +
(E) Value of forecast expense for current-operation (negative) +
(C)* Value of current operation capital change forecast
*Note:
(C) can have a positive or negative value

The three components of current-operation value will be referred to as the revenue value (R), the expense value (E) and the capital value (C). Examination of the equation in Table 4 shows that there are three ways to increase the value of the current-operation—increase the revenue, decrease the expense or decrease the capital requirements (note: this statement ignores a fourth way to increase value—decrease interest rate used for discounting future cash flows).

In the preferred embodiment, the revenue, expense and capital requirement forecasts for the current operation, the real options and the contingent liabilities are obtained from an advanced financial planning system database (30) from an advanced financial planning system similar to the one disclosed in U.S. Pat. No. 5,615,109. The extracted revenue, expense and capital requirement forecasts are used to calculate a cash flow for each period covered by the forecast for the enterprise by subtracting the expense and change in capital for each period from the revenue for each period. A steady state forecast for future periods is calculated after determining the steady state growth rate the best fits the calculated cash flow for the forecast time period. The steady state growth rate is used to calculate an extended cash flow forecast. The extended cash flow forecast is used to determine the Competitive Advantage Period (CAP) implicit in the enterprise market value.

While it is possible to use analysis bots to sub-divide each of the components of current operation value into a number of sub-components for analysis, the preferred embodiment has a pre-determined number of sub-components for each component of value for the enterprise. The revenue value is not subdivided. In the preferred embodiment, the expense value is subdivided into five sub-components: the cost of raw materials, the cost of manufacture or delivery of service, the cost of selling, the cost of support and the cost of administration. The capital value is subdivided into six sub-components: cash, non-cash financial assets, production equipment, other assets (non-financial, non-production assets), financial liabilities and equity. The production equipment and equity sub-components are not used directly in evaluating the elements of value.

The components and sub-components of current-operation value will be used in valuing the elements and sub-elements of value. For the calculations completed by the present invention, a transaction will be defined as any event that is logged or recorded. An element of value will be defined as “an entity or group that as a result of past transactions, forecasts or other data has provided and/or is expected to provide economic benefit to the enterprise.” An item will be defined as a single member of the group that defines an element of value. For example, an individual salesman would be an “item” in the “element of value” sales staff and a data base record could be an item in the “element of value” knowledge. The data associated with performance of an individual item will be referred to as “item variables”.

Analysis bots are used to determine element of value lives and the percentage of: the revenue value, the expense value, and the capital value that are attributable to each element of value. The resulting values are then added together to determine the valuation for different elements as shown by the example in Table 5.

TABLE 5

| | | Element/ | |
|---|---|---|---|
| Gross Value | Percentage | Life/CAP | Net Value |
| Revenue value = $120M | 20% | 80% | Value = $19.2M |
| Expense value = ($80M) | 10% | 80% | Value = ($6.4)M |
| Capital value = ($5M) | 5% | 80% | Value = ($0.2)M |
| Total value = $35M | | | |
| Net value for this element: | | | Value = $12.6M |

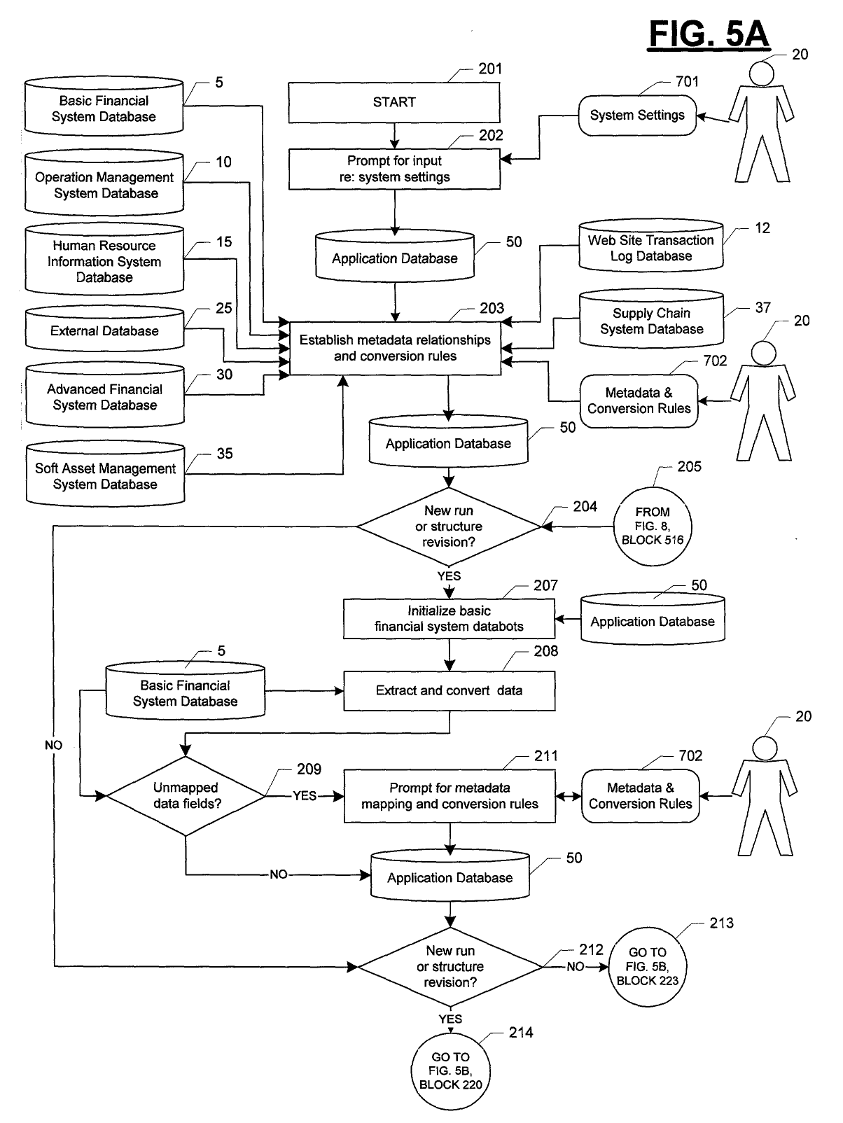

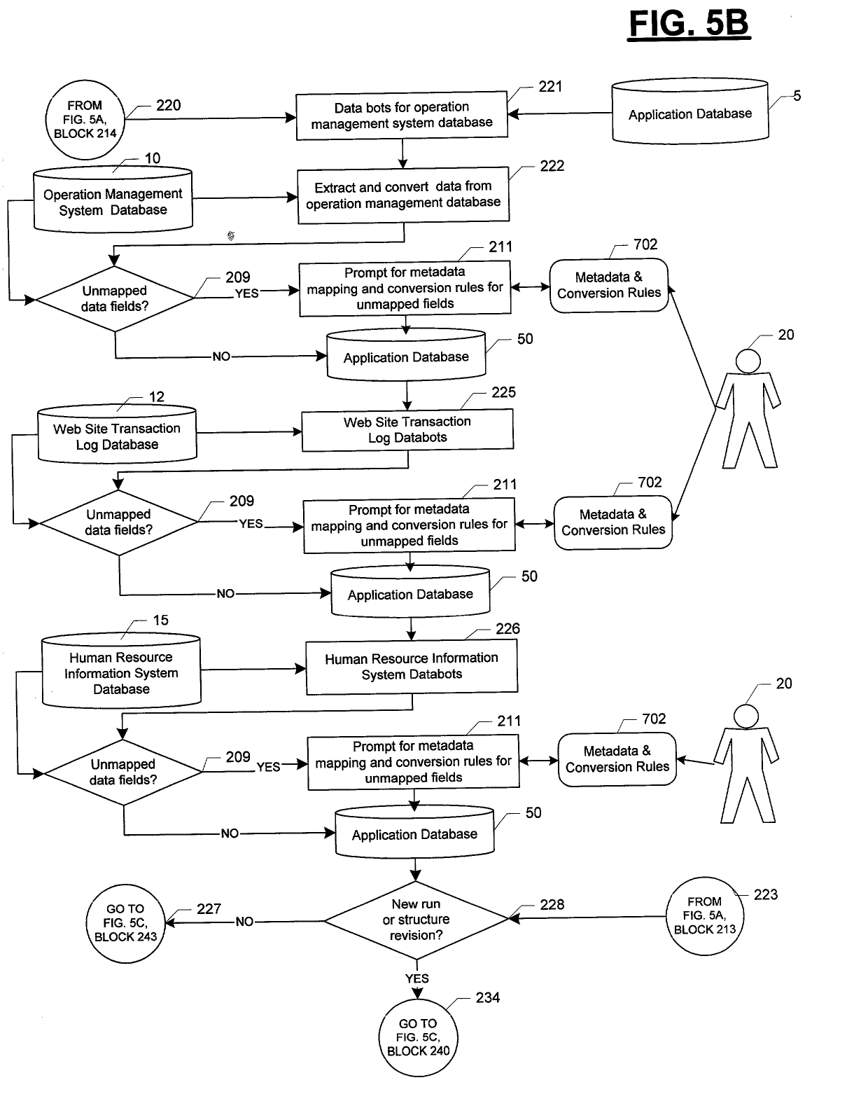

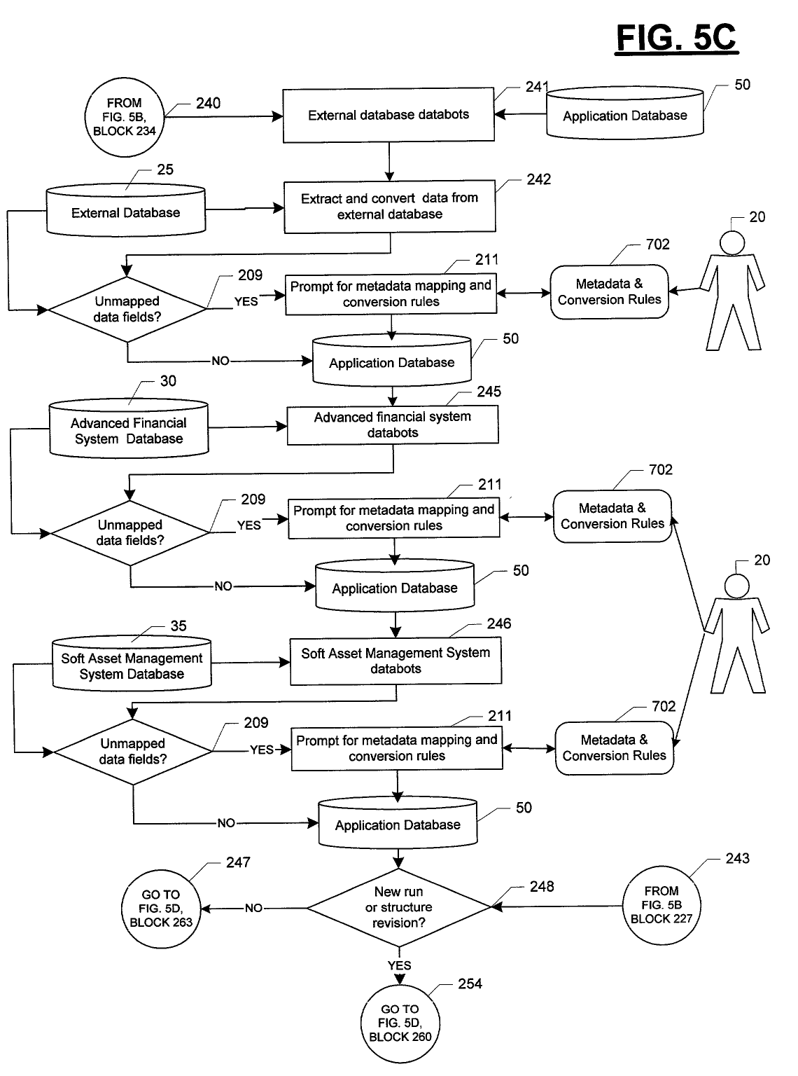

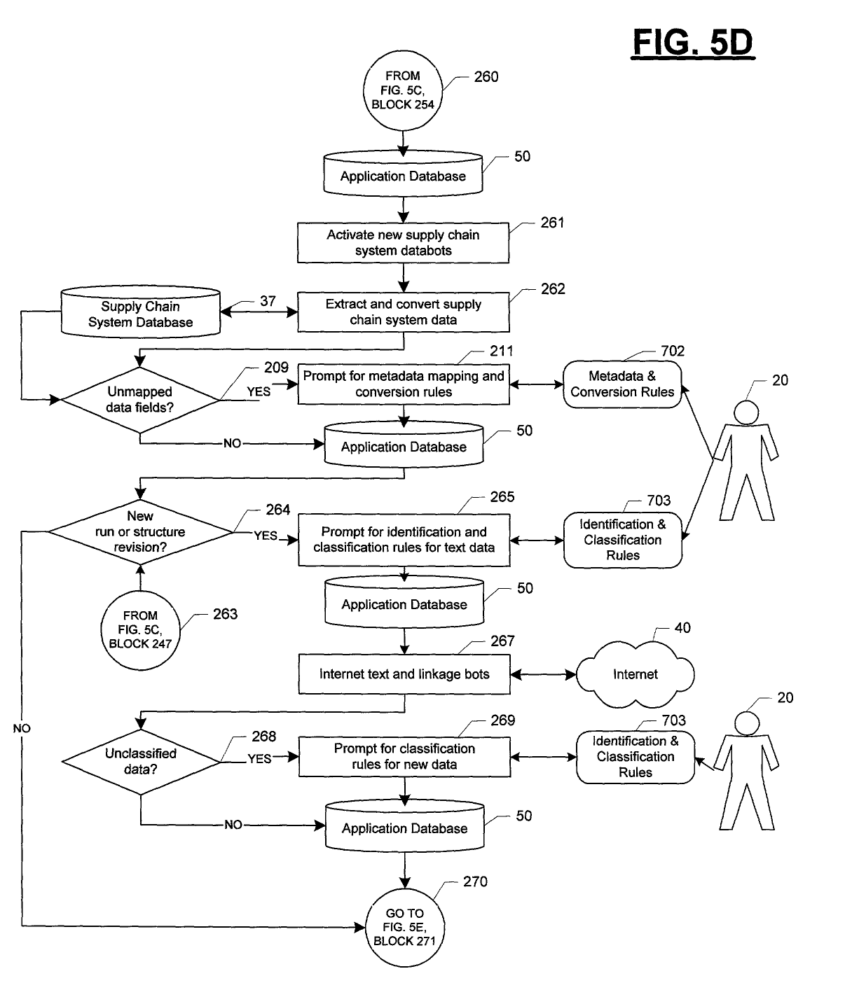

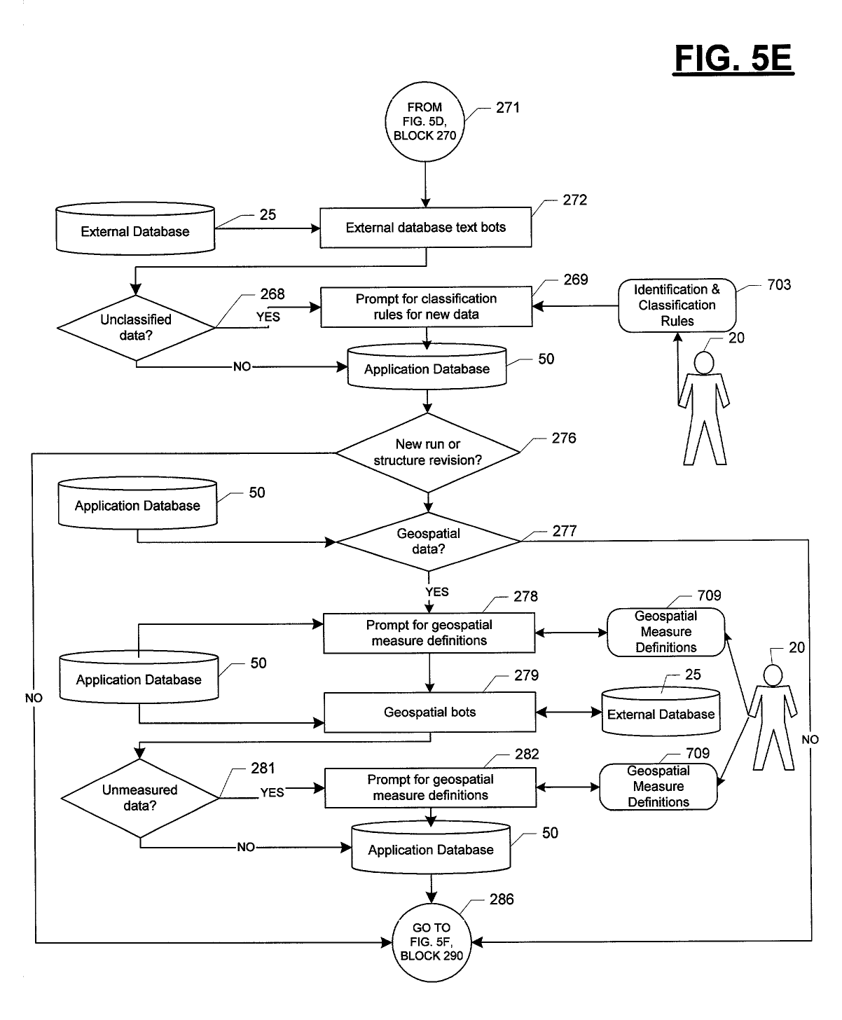

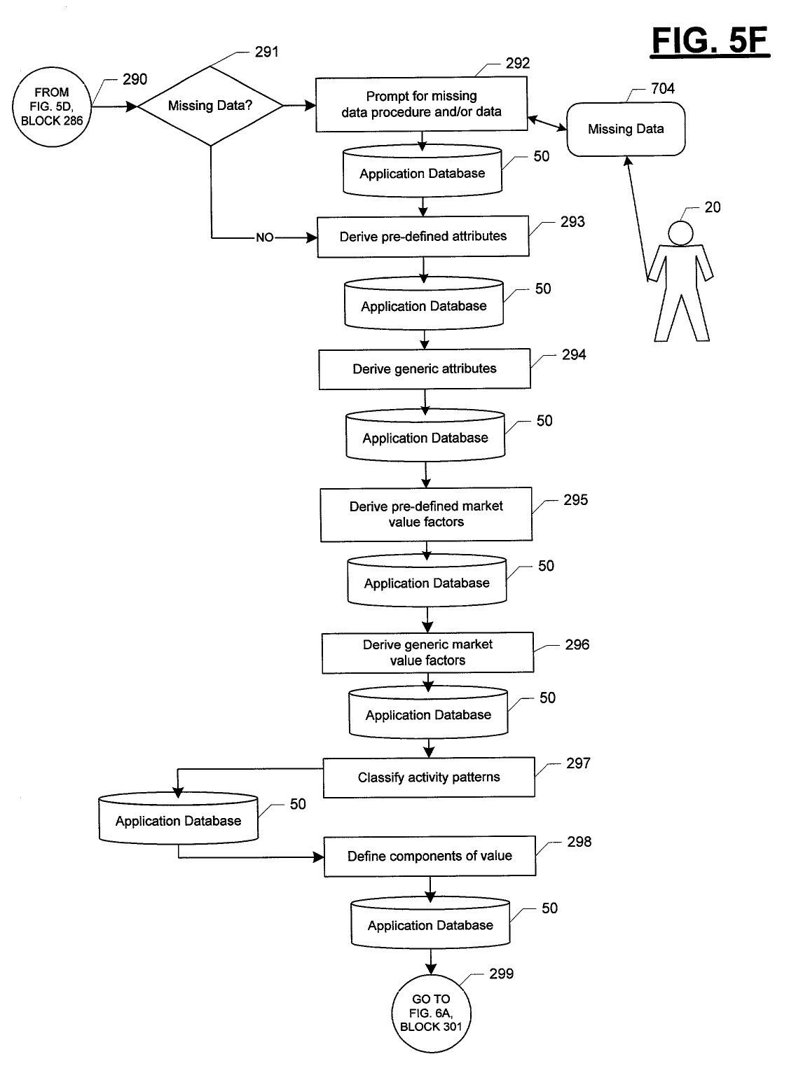

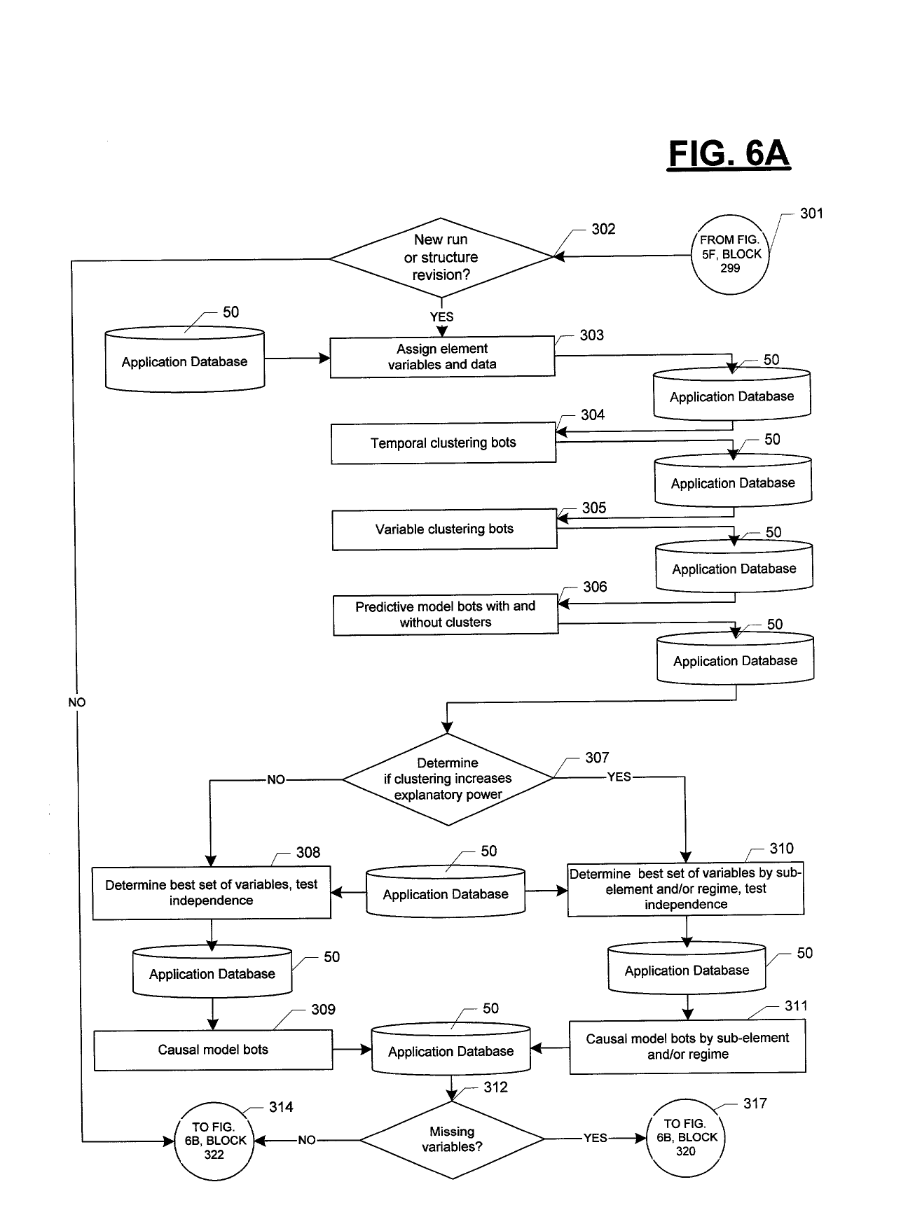

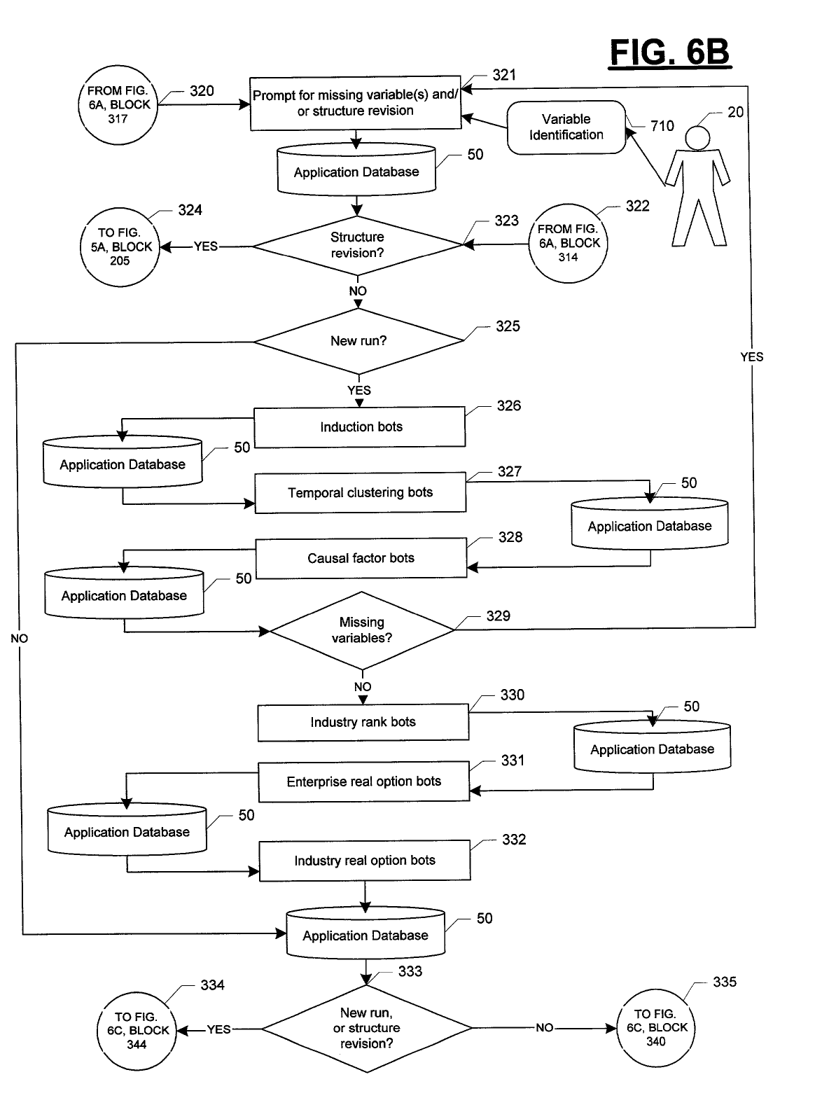

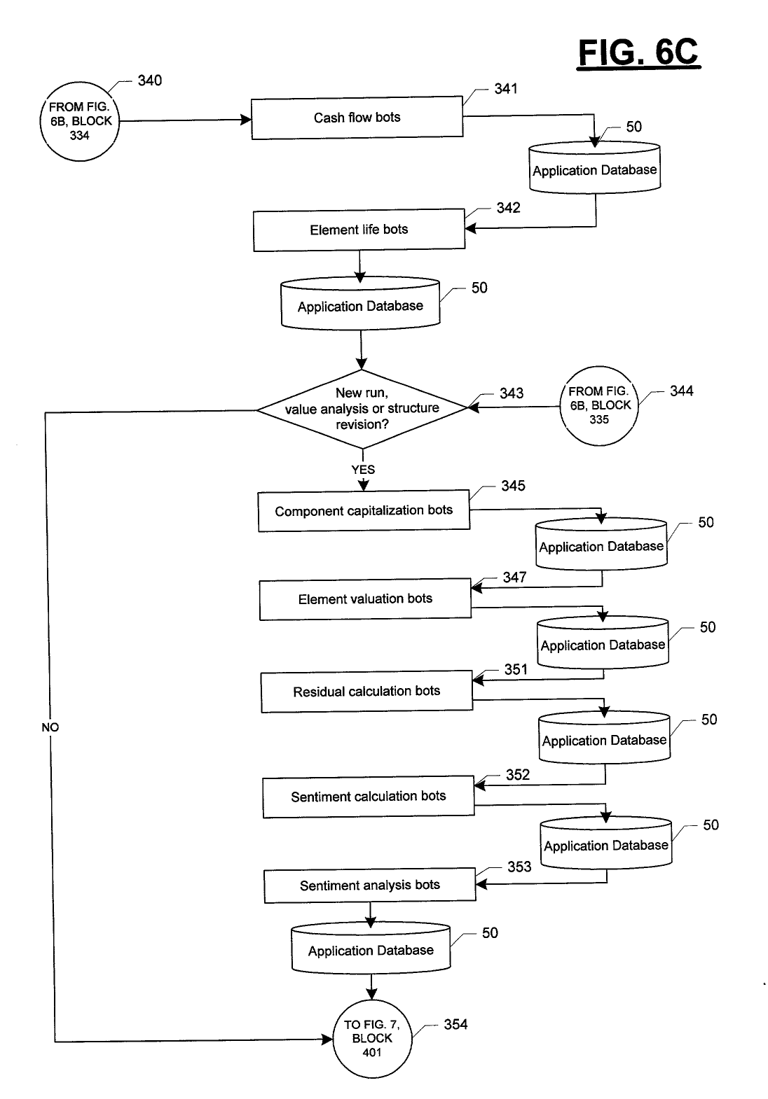

The business valuation, activity analysis and promotion coordination using the approach outlined above is completed in four distinct stages. As shown in FIG. 5A, FIG. 5B, FIG. 5C, FIG. 5D, FIG. 5E and FIG. 5F, the first stage of processing (block 200 from FIG. 1) programs bots to continually extract, aggregate, manipulate and store the data from user input and databases and the internet (5, 10, 12, 15, 25, 30, 35, 37 or 40) as required for the analysis of business value. Bots are independent components of the application that have specific tasks to perform. As shown in FIG. 6A, FIG. 6B and FIG. 6C the second stage of processing (block 300 from FIG. 1) programs analysis bots to continually:

1. Identify the item variables, item performance indicators and/or composite variables for each element of value and sub-element of value that drive the components of value (revenue, expense and changes in capital) and the market price of company equity,

2. Create vectors that summarize the performance of the item variables and item performance indicators for each element of value and sub-element of value,

3. Determine the appropriate cost of capital on the basis of relative causal element strength and value the enterprise real options and contingent liabilities;

4. Determine the appropriate cost of capital, value and allocate the industry real options to the enterprise on the basis of relative causal element strength;

5. Determine the expected life of each element of value and sub-element of value;

6. Calculate the enterprise current operation value and value the revenue, expense and capital components of said current operations using the information prepared in the previous stage of processing;

7. Specify and optimize predictive models to determine the relationship between the vectors determined in step 2 and the revenue, expense and capital component values determined in step 6,

8. Combine the results of the fifth, sixth and seventh stages of processing to determine the value of each element and sub-element; and

9. Determines the causal factors for company stock price movement, calculate market sentiment and analyze the causes of market sentiment.

The third stage of processing (block 400 from FIG. 1) produces management reports in unique, copywritten formats.

### System Settings and Data Bots

The flow diagrams in FIG. 5A, FIG. 5B, FIG. 5C, FIG. 5D, FIG. 5E and FIG. 5F detail the processing that is completed by the portion of the application software (200) that extracts, aggregates, transforms and stores the information required for system operation from the: basic financial system database (5), operation management system database (10), web site transaction log database (12), human resource information system database (15), external database (25), advanced financial system database (30), soft asset management system database (35), supply chain system database (37), the internet (40) and the user (20). A brief overview of the different databases will be presented before reviewing each step of processing completed by this portion (200) of the application software.

Corporate financial software systems are generally divided into two categories, basic and advanced. Advanced financial systems utilize information from the basic financial systems to perform financial analysis, financial planning and financial reporting functions. Virtually every commercial enterprise uses some type of basic financial system as they are required to use these systems to maintain books and records for income tax purposes. An increasingly large percentage of these basic financial systems are resident in microcomputer and workstation systems. Basic financial systems include general-ledger accounting systems with associated accounts receivable, accounts payable, capital asset, inventory, invoicing, payroll and purchasing subsystems. These systems incorporate worksheets, files, tables and databases. These databases, tables and files contain information about the company operations and its related accounting transactions. As will be detailed below, these databases, tables and files are accessed by the application software of the present invention as required to extract the information required for completing a business valuation. The system is also capable of extracting the required information from a data warehouse (or datamart) when the required information has been pre-loaded into the warehouse.

General ledger accounting systems generally store only valid accounting transactions. As is well known, valid accounting transactions consist of a debit component and a credit component where the absolute value of the debit component is equal to the absolute value of the credit component. The debits and the credits are posted to the separate accounts maintained within the accounting system. Every basic accounting system has several different types of accounts. The effect that the posted debits and credits have on the different accounts depends on the account type as shown in Table 6.

TABLE 6

| Account Type: | Debit Impact: | Credit Impact: |
|---|---|---|
| Asset | Increase | Decrease |
| Revenue | Decrease | Increase |
| Expense | Increase | Decrease |
| Liability | Decrease | Increase |
| Equity | Decrease | Increase |

General ledger accounting systems also require that the asset account balances equal the sum of the liability account balances and equity account balances at all times.

The general ledger system generally maintains summary, dollar only transaction histories and balances for all accounts while the associated subsystems, accounts payable, accounts receivable, inventory, invoicing, payroll and purchasing, maintain more detailed historical transaction data and balances for their respective accounts. It is common practice for each subsystem to maintain the detailed information shown in Table 7 for each transaction.

TABLE 7

| Subsystem | Detailed Information |
|---|---|
| Accounts | Vendor, Item(s), Transaction Date, Amount Owed, Due |
| Payable | Date, Account Number |
| Accounts | Customer, Transaction Date, Product Sold, Quantity, Price, |
| Receivable | Amount Due, Terms, Due Date, Account Number |
| Capital | Asset ID, Asset Type, Date of Purchase, Purchase Price, |
| Assets | Useful Life, Depreciation Schedule, Salvage Value |
| Inventory | Item Number, Transaction Date, Transaction Type, |
| | Transaction Qty, Location, Account Number |
| Invoicing | Customer Name, Transaction Date, Item(s) Sold, Amount |
| | Due, Due Date, Account Number |
| Payroll | Employee Name, Employee Title, Pay Frequency, Pay |
| | Rate, Account Number |
| Purchasing | Vendor, Item(s), Purchase Quantity, Purchase Price(s), Due |
| | Date, Account Number |

As is well known, the output from a general ledger system includes income statements, balance sheets and cash flow statements in well defined formats which assist management in measuring the financial performance of the firm during the prior periods when data input and system processing have been completed.

While basic financial systems are similar between firms, operation management systems vary widely depending on the type of company they are supporting. These systems typically have the ability to not only track historical transactions but to forecast future performance. For manufacturing firms, operation management systems such as Enterprise Resource Planning Systems (ERP), Material Requirement Planning Systems (MRP), Purchasing Systems, Scheduling Systems and Quality Control Systems are used to monitor, coordinate, track and plan the transformation of materials and labor into products. Systems similar to the one described above may also be useful for distributors to use in monitoring the flow of products from a manufacturer.

Operation Management Systems in manufacturing firms may also monitor information relating to the production rates and the performance of individual production workers, production lines, work centers, production teams and pieces of production equipment including the information shown in Table 8.

TABLE 8
Operation Management System - Production Information

| | |
|---|---|
| 1. | ID number (employee id/machine id) |
| 2. | Actual hours - last batch |
| 3. | Standard hours - last batch |
| 4. | Actual hours - year to date |
| 5. | Actual/Standard hours - year to date % |
| 6. | Actual setup time - last batch |
| 7. | Standard setup time - last batch |
| 8. | Actual setup hours - year to date |
| 9. | Actual/Standard setup hrs - yr to date % |
| 10. | Cumulative training time |
| 11. | Job(s) certifications |
| 12. | Actual scrap - last batch |
| 13. | Scrap allowance - last batch |
| 14. | Actual scrap/allowance - year to date |
| 15. | Rework time/unit last batch |
| 16. | Rework time/unit year to date |
| 17. | QC rejection rate - batch |
| 18. | QC rejection rate - year to date |

Operation management systems are also useful for tracking requests for service to repair equipment in the field or in a centralized repair facility. Such systems generally store information similar to that shown below in Table 9.

TABLE 9
Operation Management System - Service Call Information

| | | | |
|---|---|---|---|
| 1. | Customer name | 11. | Promised type of response |
| 2. | Customer number | 12. | Time person dispatched to call |
| 3. | Contract number | 13. | Name of person handling call |
| 4. | Service call number | 14. | Time of arrival on site |
| 5. | Time call received | 15. | Time of repair completion |
| 6. | Product(s) being fixed | 16. | Actual response type |
| 7. | Serial number of equipment | 17. | Part(s) replaced |
| 8. | Name of person placing call | 18. | Part(s) repaired |
| 9. | Name of person accepting call | 19. | 2nd call required |
| 10. | Promised response time | 20. | 2nd call number |

Web site transaction log databases keep a detailed record of every visit to a web site, they can be used to trace the path of each visitor to the web site and upon further analysis can be used to identify patterns that are most likely to result in purchases and those that are most likely to result in abandonment. If the customer (21) has previously visited the site and/or has been tagged by one of the web marketing vendors such as Avenue A or Double Click, the customer's browser appliance (91) may contain one or more “cookies” that identify the customer in sufficient detail to categorize him or her when they first connect with a web site. This information can be used to develop a personalized greeting, such as “Welcome Back Tom!” This information can also be used to identify which promotion would generate the most value for the company using the system. Web site transaction logs generally contain the information shown in Table 10.

TABLE 10
Web Site Transaction Log Database

| | | | |
|---|---|---|---|
| 1. | Customer's URL | 6. | Referring site |
| 2. | Date and time of visit | 7. | URL of site visited next |
| 3. | Pages visited | 8. | Downloaded file volume and type |
| 4. | Length of page visit (time) | 9. | Cookies |
| 5. | Type of browser used | 10. | Transactions |

Computer based human resource systems may some times be packaged or bundled within enterprise resource planning systems such as those available from SAP, Oracle and Peoplesoft. Human resource systems are increasingly used for storing and maintaining corporate records concerning active employees in sales, operations and the other functional specialties that exist within a modern corporation. Storing records in a centralized system facilitates timely, accurate reporting of overall manpower statistics to the corporate management groups and the various government agencies that require periodic updates. In some cases human resource systems include the company payroll system as a subsystem. In the preferred embodiment of the present invention, the payroll system is part of the basic financial system. These systems can also be used for detailed planning regarding future manpower requirements. Human resource systems typically incorporate worksheets, files, tables and databases that contain information about the current and future employees. As will be detailed below, these databases, tables and files are accessed by the application software of the present invention as required to extract the information required for completing a business valuation. It is common practice for human resource systems to store the information shown in Table 11 for each employee.

TABLE 11
Human Resource System Information

| | | |
|---|---|---|
| 1. | Employee name | 10. Employee start date - company |
| 2. | Job title | 11. Employee start date - department |
| 3. | Job code | 12. Employee start date - current job |
| 4. | Rating | 13. Training courses completed |
| 5. | Division | 14. Cumulative training expenditures |
| 6. | Department | 15. Salary history |
| 7. | Employee No./(Social | 16. Current salary |
| | Security Number) | |
| 8. | Year to date - hours paid | 17. Educational background |
| 9. | Year to date - hours worked | 18. Current supervisor |

External databases can be used for obtaining information that enables the definition and evaluation of a variety of things including elements of value, market value factors, industry real options and composite variables. In some cases information from these databases can be used to supplement information obtained from the other databases and the internet (5, 10, 12, 15, 30, 35, 37 and 40). In the system of the present invention, the information extracted from external databases (25) can be in the forms listed in Table 12.

TABLE 12
Types of information

| | |
|---|---|
| 1) | Numeric information such as that found in the SEC Edgar database |
| | and the databases of financial infomediaries such as FirstCall, |
| | IBES and Compustat, |
| 2) | Text information such as that found in the Lexis Nexis database and |
| | databases containing past issues from specific publications, |
| 3) | Cookie information such as that provided by web intermediaries that |
| | helps identify the type of customer connected to the company web |
| | site, |
| 4) | Multimedia information such as video and audio clips, and |
| 5) | Geospatial data. |

The system of the present invention uses different “bot” types to process each distinct data type from external databases (25). The same “bot types” are also used for extracting each of the different types of data from the internet (40). The system of the present invention must have access to at least one external database (25) that provides information regarding the equity prices for the enterprise and the equity prices and financial performance of competitors.

Advanced financial systems may also use information from external databases (25) and the internet (40) in completing their processing. Advanced financial systems include financial planning systems and activity based costing systems. Activity based costing systems may be used to supplement or displace the operation of the expense component analysis segment of the present invention as disclosed previously. Financial planning systems generally use the same format used by basic financial systems in forecasting income statements, balance sheets and cash flow statements for future periods. Management uses the output from financial planning systems to highlight future financial difficulties with a lead time sufficient to permit effective corrective action and to identify problems in company operations that may be reducing the profitability of the business below desired levels. These systems are most often developed by individuals within companies using two and three dimensional spreadsheets such as Lotus 1-2-3®, Microsoft Excel® and Quattro Prom. In some cases, financial planning systems are built within an executive information system (EIS) or decision support system (DSS). For the preferred embodiment of the present invention, the advanced financial system database (30) is similar to the financial planning system database detailed in U.S. Pat. No. 5,165,109 for “Method of and System for Generating Feasible, Profit Maximizing Requisition Sets”, by Jeff S. Eder, the disclosure of which is incorporated herein by reference.

While advanced financial planning systems have been around for some time, soft asset management systems are a relatively recent development. Their appearance is further proof of the increasing importance of “soft” assets. Soft asset management systems include: alliance management systems, brand management systems, customer relationship management systems, channel management systems, intellectual property management systems, process management systems and vendor management systems. Soft asset management systems are similar to operation management systems in that they generally have the ability to forecast future events as well as track historical occurrences. Customer relationship management systems are the most well established soft asset management systems at this point and will the focus of the discussion regarding soft asset management system data. In firms that sell customized products, the customer relationship management system is generally integrated with an estimating system that tracks the flow of estimates into quotations, orders and eventually bills of lading and invoices. In other firms that sell more standardized products, customer relationship management systems generally are used to track the sales process from lead generation to lead qualification to sales call to proposal to acceptance (or rejection) and delivery. All customer relationship management systems would be expected to track all of the customer's interactions with the enterprise after the first sale and store information similar to that shown below in Table 13.

TABLE 13
Customer Relationship Management System - Information

| | |
|---|---|
| 1. Customer/Potential customer name | 9. Sales call history |
| 2. Customer number | 10. Sales contact history |
| 3. Address | 11. Sales history: product/qty/price |
| 4. Phone number | 12. Quotations: product/qty/price |
| 5. Source of lead | 13. Custom product percentage |
| 6. Date of first purchase | 14. Payment history |
| 7. Date of last purchase | 15. Current A/R balance |
| 8. Last sales call/contact | 16. Average days to pay |

Supply chain management system databases (37) contain information that may have been in operation management system databases (10) in the past. These systems provide enhanced visibility into the availability of goods and promote improved coordination between customers and their suppliers. All supply chain management systems would be expected to track all of the items ordered by the enterprise after the first purchase and store information similar to that shown below in Table 14.

TABLE 14
Supply Chain System Information

| | |
|---|---|
| 1. Stock keeping unit | 7. Quantity available today |
| 2. Vendor | 8. Quantity available next 7 days |
| 3. Total quantity on order | 9. Quantity available next 30 days |
| 4. Total quantity in transit | 10. Quantity available next 90 days |
| 5. Total quantity on back order | 11. Quoted lead time |
| 6. Total quantity in inventory | 12. Actual average lead time |

System processing of the information from the different databases (5, 10, 12, 15, 25, 30, 35 and 37) and the internet (40) described above starts in a block 201, FIG. 5A, which immediately passes processing to a software block 202. The software in block 202 prompts the user (20) via the system settings data window (701) to provide system setting information. The system setting information entered by the user (20) is transmitted via the network (45) back to the application server (120) where it is stored in the system settings table (140) in the application database (50) in a manner that is well known. The specific inputs the user (20) is asked to provide at this point in processing are shown in Table 15.

TABLE 15

| | |
|---|---|
| 1. | New run or structure revision? |
| 2. | Continuous, If yes, frequency? (hourly, daily, weekly, monthly or |
| | quarterly) |
| 3. | Structure of enterprise (department, etc.) |
| 4. | Enterprise checklist |
| 5. | Base account structure |
| 6. | Metadata standard (XML, MS OIM, MDC) |
| 7. | Location of basic financial system database and metadata |
| 8. | Location of advanced financial system database and metadata |
| 9. | Location of human resource information system database and |
| | metadata |
| 10. | Location of operation management system database and metadata |
| 11. | Location of soft asset management system databases and metadata |
| 12. | Location of external database and metadata |
| 13. | Location of web site transaction log database and metadata |
| 14. | Location of supply chain management system database and metadata |
| 15. | Location of account structure |
| 16. | Base currency |
| 17. | Location of database and metadata for equity information |
| 18. | Location of database and metadata for debt information |
| 19. | Location of database and metadata for tax rate information |
| 20. | Location of database and metadata for currency conversion rate |
| | information |
| 21. | Geospatial data? If yes, identity of geocoding service. |
| 22. | The maximum number of generations to be processed without |
| | improving fitness |
| 23. | Default clustering algorithm (selected from list) and maximum cluster |
| | number |
| 24. | Amount of cash and marketable securities required for day to day |
| | operations |
| 25. | Total cost of capital (weighted average cost of equity, debt and risk |
| | capital) |
| 26. | Number of months a product is considered new after it is first |
| | produced |
| 27. | Enterprise industry segments (SIC Code) |
| 28. | Primary competitors by industry segment |
| 29. | Management report types (text, graphic, both) |
| 30. | Default reports |
| 31. | Default missing data procedure |
| 32. | Maximum time to wait for user input |
| 33. | Maximum discount rate for new projects (real option valuation) |
| 34. | Maximum number of sub-elements |

The enterprise checklists are used by a “rules” engine (such as the one available from Neuron Data) in block 202 to influence the number and type of items with pre-defined metadata mapping for each category of value. For example, if the checklists indicate that the enterprise is focused on branded, consumer markets, then additional brand related factors will be pre-defined for mapping. The application of these system settings will be further explained as part of the detailed explanation of the system operation.

The software in block 202 can use the current system date to determine the time periods (months) that require data in order to complete the current operation and the real option valuations and stores the resulting date range in the system settings table (140). In the preferred embodiment the valuation of the current operation by the system utilizes basic financial, advanced financial, soft asset management, external database and human resource data for the three year period before and the three year forecast period after the current date. The user (20) also has the option of specifying the data periods that will be used for completing system calculations.

After the storage of system setting data is complete, processing advances to a software block 203. The software in block 203 prompts the user (20) via the metadata and conversion rules window (702) to map metadata using the standard specified by the user (20) (XML, Microsoft Open Information Model of the Metadata Coalitions specification) from the basic financial system database (5), the operation management system database (10), the web site transaction log database (12), the human resource information system database (15), the external database (25), the advanced financial system database (30), the soft asset management system database (35) and the supply chain system database (37) to the enterprise hierarchy stored in the system settings table (140) and to the pre-specified fields in the metadata mapping table (141). Pre-specified fields in the metadata mapping table include: the revenue, expense and capital components and sub-components for the enterprise and pre-specified fields for expected value drivers. Because the bulk of the information being extracted is financial information, the metadata mapping often takes the form of specifying the account number ranges that correspond to the different fields in the metadata mapping table (141). Table 16 shows the base account number structure that the account numbers in the other systems must align with. For example, using the structure shown below, the revenue component for the enterprise could be specified as enterprise 01, any department number, accounts 400 to 499 (the revenue account range) with any sub-account.

TABLE 16

| Account | | | | |
|---|---|---|---|---|
| Number | 01 - | 902 (any) - | 477 - | 86 (any) |
| Segment | Enterprise | Department | Account | Sub-account |
| Subgroup | Workstation | Marketing | Revenue | Singapore |
| Position | 4 | 3 | 2 | 1 |

As part of the metadata mapping process, any database fields that are not mapped to pre-specified fields are defined by the user (20) as component of value, elements of value or non-relevant attributes and “mapped” in the metadata mapping table (141) to the corresponding fields in each database in a manner identical to that described above for the pre-specified fields. After all fields have been mapped to the metadata mapping table (141), the software in block 203 prompts the user (20) via the metadata and conversion rules window (702) to provide conversion rules for each metadata field for each data source. Conversion rules will include information regarding currency conversions and conversion for units of measure that may be required to accurately and consistently analyze the data. The inputs from the user (20) regarding conversion rules are stored in the conversion rules table (142) in the application database. When conversion rules have been stored for all fields from every data source, then processing advances to a software block 204.

The software in block 204 checks the system settings table (140) in the application database (50) to determine if the current calculation is a new calculation or a structure change. If the calculation is not a new calculation or a structure change then processing advances to a software block 212. Alternatively, if the calculation is new or a structure change, then processing advances to a software block 207.

The software in block 207 checks the bot date table (149) and deactivates any basic financial system data bots with creation dates before the current system date and retrieves information from the system settings table (140), metadata mapping table (141) and conversion rules table (142). The software in block 207 then initializes data bots for each field in the metadata mapping table (141) that mapped to the basic financial system database (5) in accordance with the frequency specified by user (20) in the system settings table (140). Bots are independent components of the application that have specific tasks to perform. In the case of data acquisition bots, their tasks are to extract and convert data from a specified source and then store it in a specified location. Each data bot initialized by software block 207 will store its data in the basic financial system table (143). Every data acquisition bot for every data source contains the information shown in Table 17.

TABLE 17

| | |
|---|---|
| 1. | Unique ID number (based on date, hour, minute, second of creation) |
| 2. | The data source location |
| 3. | Mapping information |
| 4. | Timing of extraction |
| 5. | Conversion rules (if any) |
| 6. | Storage location (to allow for tracking of source and destination |
| | events) |
| 7. | Creation date (date, hour, minute, second) |

After the software in block 207 initializes all the bots for the basic financial system database, processing advances to a block 208. In block 208, the bots extract and convert data in accordance with their preprogrammed instructions in accordance with the frequency specified by user (20) in the system settings table (140). As each bot extracts and converts data from the basic financial system database (5), processing advances to a software block 209 before the bot completes data storage. The software in block 209 checks the basic financial system metadata to see if all fields have been extracted. If the software in block 209 finds no unmapped data fields, then the extracted, converted data is stored in the basic financial system table (143). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the basic financial system table (143). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing passes on to software block 212.

The software in block 212 checks the system settings table (140) in the application database (50) to determine if the current calculation is a new calculation or a structure change. If the calculation is not a new calculation or a structure change then processing advances to a software block 228. Alternatively, if the calculation is new or a structure change, then processing advances to a software block 221.

The software in block 221 checks the bot date table (149) and deactivates any operation management system data bots with creation dates before the current system date and retrieves information from the system settings table (140), metadata mapping table (141) and conversion rules table (142). The software in block 221 then initializes data bots for each field in the metadata mapping table (141) that mapped to the operation management system database (10) in accordance with the frequency specified by user (20) in the system settings table (140). Each data bot initialized by software block 221 will store its data in the operation system table (144).

After the software in block 221 initializes all the bots for the operation management system database (10), processing advances to a block 222. In block 222, the bots extract and convert data in accordance with their preprogrammed instructions with the frequency specified by user (20) in the system settings table (140). As each bot extracts and converts data from the operation management system database (10), processing advances to a software block 209 before the bot completes data storage. The software in block 209 checks the operation management system metadata to see if all fields have been extracted. If the software in block 209 finds no unmapped data fields, then the extracted, converted data is stored in the operation system table (144). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the operation system table (144). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to a software block 225.

The software in block 225 checks the bot date table (149) and deactivates any web site transaction log data bots with creation dates before the current system date and retrieves information from the system settings table (140), metadata mapping table (141) and conversion rules table (142). The software in block 225 then initializes data bots for each field in the metadata mapping table (141) that mapped to the web site transaction log database (12) in accordance with the frequency specified by user (20) in the system settings table (140). Each data bot initialized by software block 225 will store its data in the web log data table (172).

After the software in block 225 initializes all the bots for the web site transaction log database (12), the bots extract and convert data in accordance with their preprogrammed instructions in accordance with the frequency specified by user (20) in the system settings table (140). As each bot extracts and converts data from the web site transaction log database (12), processing advances to a software block 209 before the bot completes data storage. The software in block 209 checks the web site transaction log metadata to see if all fields have been extracted. If the software in block 209 finds no unmapped data fields, then the extracted, converted data is stored in the web log data table (172). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the web log data table (172). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to a software block 226.

The software in block 226 checks the bot date table (149) and deactivates any human resource information system data bots with creation dates before the current system date and retrieves information from the system settings table (140), metadata mapping table (141) and conversion rules table (142). The software in block 226 then initializes data bots for each field in the metadata mapping table (141) that mapped to the human resource information system database (15) in accordance with the frequency specified by user (20) in the system settings table (140). Each data bot initialized by software block 226 will store its data in the human resource system table (145).

After the software in block 226 initializes all the bots for the human resource information system database, the bots extract and convert data in accordance with their preprogrammed instructions in accordance with the frequency specified by user (20) in the system settings table (140). As each bot extracts and converts data from the human resource information system database (15), processing advances to a software block 209 before the bot completes data storage. The software in block 209 checks the human resource information system metadata to see if all fields have been extracted. If the software in block 209 finds no unmapped data fields, then the extracted, converted data is stored in the human resource system table (145). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the human resource system table (145). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 228.

The software in block 228 checks the system settings table (140) in the application database (50) to determine if the current calculation is a new calculation or a structure change. If the calculation is not a new calculation or a structure change then processing advances to a software block 248. Alternatively, if the calculation is new or a structure change, then processing advances to a software block 241.

The software in block 241 checks the bot date table (149) and deactivates any external database data bots with creation dates before the current system date and retrieves information from the system settings table (140), metadata mapping table (141) and conversion rules table (142). The software in block 241 then initializes data bots for each field in the metadata mapping table (141) that mapped to the external database (25) in accordance with the frequency specified by user (20) in the system settings table (140). Each data bot initialized by software block 241 will store its data in the external database table (146).

After the software in block 241 initializes all the bots for the external database, processing advances to a block 242. In block 242, the bots extract and convert data in accordance with their preprogrammed instructions. As each bot extracts and converts data from the external database (25), processing advances to a software block 209 before the bot completes data storage. The software in block 209 checks the external database metadata to see if all fields have been extracted. If the software in block 209 finds no unmapped data fields, then the extracted, converted data is stored in the external database table (146). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the external database table (146). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to a software block 245.

The software in block 245 checks the bot date table (149) and deactivates any advanced financial system data bots with creation dates before the current system date and retrieves information from the system settings table (140), metadata mapping table (141) and conversion rules table (142). The software in block 245 then initializes data bots for each field in the metadata mapping table (141) that mapped to the advanced financial system database (30) in accordance with the frequency specified by user (20) in the system settings table (140). Each data bot initialized by software block 245 will store its data in the advanced finance system table (147).

After the software in block 245 initializes all the bots for the advanced financial system database, the bots extract and convert data in accordance with their preprogrammed instructions in accordance with the frequency specified by user (20) in the system settings table (140). As each bot extracts and converts data from the advanced financial system database (30), processing advances to a software block 209 before the bot completes data storage. The software in block 209 checks the advanced financial system database metadata to see if all fields have been extracted. If the software in block 209 finds no unmapped data fields, then the extracted, converted data is stored in the advanced finance system table (147). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the advanced finance system table (147). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 246.

The software in block 246 checks the bot date table (149) and deactivates any soft asset management system data bots with creation dates before the current system date and retrieves information from the system settings table (140), metadata mapping table (141) and conversion rules table (142). The software in block 246 then initializes data bots for each field in the metadata mapping table (141) that mapped to a soft asset management system database (35) in accordance with the frequency specified by user (20) in the system settings table (140). Extracting data from each soft asset management system ensures that the management of each soft asset is considered and prioritized within the overall financial models for each enterprise. Each data bot initialized by software block 246 will store its data in the soft asset system table (148).

After the software in block 246 initializes bots for all soft asset management system databases, the bots extract and convert data in accordance with their preprogrammed instructions in accordance with the frequency specified by user (20) in the system settings table (140). As each bot extracts and converts data from the soft asset management system database (35), processing advances to a software block 209 before the bot completes data storage. The software in block 209 checks the metadata for the soft asset management system databases to see if all fields have been extracted. If the software in block 209 finds no unmapped data fields, then the extracted, converted data is stored in the soft asset system table (148). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the soft asset system table (148). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 248.

The software in block 248 checks the system settings table (140) in the application database (50) to determine if the current calculation is a new calculation or a structure change. If the calculation is not a new calculation or a structure change then processing advances to a software block 264. Alternatively, if the calculation is new or a structure change, then processing advances to a software block 261.

The software in block 261 checks the bot date table (149) and deactivates any supply chain system data bots with creation dates before the current system date and retrieves information from the system settings table (140), metadata mapping table (141) and conversion rules table (142). The software in block 261 then initializes data bots for each field in the metadata mapping table (141) that mapped to a supply chain system database (37) in accordance with the frequency specified by user (20) in the system settings table (140). Each data bot initialized by software block 261 will store its data in the supply chain system table (174).

After the software in block 261 initializes bots for all supply chain system databases, processing advances to a block 262. In block 262, the bots extract and convert data in accordance with their preprogrammed instructions in accordance with the frequency specified by user (20) in the system settings table (140). As each bot extracts and converts data from the supply chain system databases (37), processing advances to a software block 209 before the bot completes data storage. The software in block 209 checks the metadata for the supply chain system database (37) to see if all fields have been extracted. If the software in block 209 finds no unmapped data fields, then the extracted, converted data is stored in the supply chain system table (174). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the supply chain system table (174). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 264.

The software in block 264 checks the system settings table (140) in the application database (50) to determine if the current calculation is a new calculation or a structure change. If the calculation is not a new calculation or a structure change then processing advances to a software block 276. Alternatively, if the calculation is new or a structure change, then processing advances to a software block 265.

The software in block 265 prompts the user (20) via the identification and classification rules window (703) to identify keywords such as company names, brands, trademarks, competitors for pre-specified fields in the metadata mapping table (141). The user (20) also has the option of mapping keywords to other fields in the metadata mapping table (141). After specifying the keywords, the user (20) is prompted to select and classify descriptive terms for each keyword. The input from the user (20) is stored in the keyword table (150) in the application database before processing advances to a software block 267.

The software in block 267 checks the bot date table (149) and deactivates any internet text and linkage bots with creation dates before the current system date and retrieves information from the system settings table (140), the metadata mapping table (141) and the keyword table (150). The software in block 267 then initializes internet text and linkage bots for each field in the metadata mapping table (141) that mapped to a keyword in accordance with the frequency specified by user (20) in the system settings table (140).

Bots are independent components of the application that have specific tasks to perform. In the case of text and linkage bots, their tasks are to locate, count and classify keyword matches and linkages from a specified source and then store their findings in a specified location. Each text and linkage bot initialized by software block 267 will store the location, count and classification data it discovers in the classified text table (151). Multimedia data can be processed using bots with essentially the same specifications if software to translate and parse the multimedia content is included in each bot. Every internet text and linkage bot contains the information shown in Table 18.

TABLE 18
1. Unique ID number (based on date, hour, minute, second of creation)
2. Creation date (date, hour, minute, second)
3. Storage location
4. Mapping information
5. Home URL
6. Keyword
7. Descriptive term 1
To
7 + n. Descriptive term n

After they are activated the text and linkage bots locate and classify data from the internet (40) in accordance with their programmed instructions in accordance with the frequency specified by user (20) in the system settings table (140). As each text and linkage bot locates and classifies data from the internet (40) processing advances to a software block 268 before the bot completes data storage. The software in block 268 checks to see if all linkages are identified and all keyword hits are associated with descriptive terms that have been classified. If the software in block 268 doesn't find any unclassified “hits” or “links”, then the address, counts and classified text are stored in the classified text table (151). Alternatively, if there are terms that haven't been classified or links that haven't been identified, then processing advances to a block 269. The software in block 269 prompts the user (20) via the identification and classification rules window (703) to provide classification rules for each new term. The information regarding the new classification rules is stored in the keyword table (150) while the newly classified text and linkages are stored in the classified text table (151). It is worth noting at this point that the activation and operation of bots that don't have unclassified fields continues. Only bots with unclassified fields will “wait” for user input before completing data storage. The new classification rules will be used the next time bots are initialized in accordance with the frequency established by the user (20). In either event, system processing then passes on to a software block 272.

The software in block 272 checks the bot date table (149) and deactivates any external database text bots with creation dates before the current system date and retrieves information from the system settings table (140), the metadata mapping table (141) and the keyword table (150). The software in block 272 then initializes external database bots for each field in the metadata mapping table (141) that mapped to a keyword in accordance with the frequency specified by user (20) in the system settings table (140). Every bot initialized by software block 272 will store the location, count and classification of data it discovers in the classified text table (151). Every external database bot contains the information shown in Table 19.

TABLE 19
1. Unique ID number (based on date, hour, minute, second of creation)
2. Creation date (date, hour, minute, second)
3. Storage location
4. Mapping information
5. Data source
6. Keyword
7. Storage location
8. Descriptive term 1
To
8 + n. Descriptive term n

Once activated, the bots locate data from the external database (25) in accordance with its programmed instructions with the frequency specified by user (20) in the system settings table (140). As each bot locates and classifies data from the external database (25) processing advances to a software block 268 before the bot completes data storage. The software in block 268 checks to see if all keyword hits are associated with descriptive terms that have been classified. If the software in block 268 doesn't find any unclassified “hits”, then the address, count and classified text are stored in the classified text table (151) or the external database table (146) as appropriate. Alternatively, if there are terms that haven't been classified, then processing advances to a block 269. The software in block 269 prompts the user (20) via the identification and classification rules window (703) to provide classification rules for each new term. The information regarding the new classification rules is stored in the keyword table (150) while the newly classified text is stored in the classified text table (151). It is worth noting at this point that the activation and operation of bots that don't have unclassified fields continues. Only bots with unclassified fields “wait” for user input before completing data storage. The new classification rules will be used the next time bots are initialized in accordance with the frequency established by the user (20). In either event, system processing then passes on to software block 276.

The software in block 276 checks the system settings table (140) in the application database (50) to determine if the current calculation is a new calculation or a structure change. If the calculation is not a new calculation or a structure change then processing advances to a software block 291. Alternatively, if the calculation is new or a structure change, then processing advances to a software block 277.

The software in block 277 checks the system settings table (140) to see if there is geocoded data in the application database (50) and to determine which on-line geocoding service (Centrus™ from QM Soft or MapMarker™ from Mapinfo) is being used. If geospatial data is not being used, then processing advances to a block 291. Alternatively, if the software in block 277 determines that geospatial data are being used, processing advances to a software block 278.

The software in block 278 prompts the user (20) via the geospatial measure definitions window (709) to define the measures that will be used in evaluating the elements of value. After specifying the measures, the user (20) is prompted to select the geospatial locus for each measure from the data already stored in the application database (50). The input from the user (20) is stored in the geospatial measures table (152) in the application database before processing advances to a software block 279.

The software in block 279 checks the bot date table (149) and deactivates any geospatial bots with creation dates before the current system date and retrieves information from the system settings table (140), the metadata mapping table (141) and the geospatial measures table (152). The software in block 279 then initializes geospatial bots for each field in the metadata mapping table (141) that mapped to geospatial data in the application database (50) in accordance with the frequency specified by user (20) in the system settings table (140).

Bots are independent components of the application that have specific tasks to perform. In the case of geospatial bots, their tasks are to calculate user specified measures using a specified geocoding service and then store the measures in a specified location. Each geospatial bot initialized by software block 279 will store the measures it calculates in the application database table where the geospatial data was found. Tables that could include geospatial data include: the basic financial system table (143), the operation system table (144), the human resource system table (145), the external database table (146), the advanced finance system table (147) and the soft asset system table (148). Every geospatial bot contains the information shown in Table 20.

TABLE 20
1. Unique ID number (based on date, hour, minute, second of creation)
2. Creation date (date, hour, minute, second)
3. Mapping information
4. Storage location
5. Geospatial locus
6. Geospatial measure
7. Geocoding service

After being activated, the geospatial bots locate data and complete measurements in accordance with their programmed instructions with the frequency specified by the user (20) in the system settings table (140). As each geospatial bot retrieves data and calculates the geospatial measures that have been specified, processing advances to a block 281 before the bot completes data storage. The software in block 281 checks to see if all geospatial data located by the bot has been measured. If the software in block 281 doesn't find any unmeasured data, then the measurement is stored in the application database (50). Alternatively, if there are data elements that haven't been measured, then processing advances to a block 282. The software in block 282 prompts the user (20) via the geospatial measures definition window (709) to provide measurement rules for each new term. The information regarding the new measurement rules is stored in the geospatial measures table (152) while the newly calculated measurement is stored in the appropriate table in the application database (50). It is worth noting at this point that the activation and operation of bots that don't have unmeasured fields continues. Only the bots with unmeasured fields “wait” for user input before completing data storage. The new measurement rules will be used the next time bots are initialized in accordance with the frequency established by the user (20). In either event, system processing then passes on to a software block 291.

The software in block 291 checks: the basic financial system table (143), the operation system table (144), the human resource system table (145), the external database table (146), the advanced finance system table (147), the soft asset system table (148), the classified text table (151) and the geospatial measures table (152) to see if data are missing from any of the periods required for system calculation. The range of required dates was previously calculated by the software in block 202. If there are no data missing from any period, then processing advances to a software block 293. Alternatively, if there are missing data for any field for any period, then processing advances to a block 292.

The software in block 292, prompts the user (20) via the missing data window (704) to specify the method to be used for filling the blanks for each item that is missing data. Options the user (20) can choose for filling the blanks include: the average value for the item over the entire time period, the average value for the item over a specified period, zero, the average of the preceding item and the following item values and direct user input for each missing item. If the user (20) doesn't provide input within a specified interval, then the default missing data procedure specified in the system settings table (140) is used. When all the blanks have been filled and stored for all of the missing data, system processing advances to a block 293.

The software in block 293 calculates attributes by item for each numeric data field in the basic financial system table (143), the operation system table (144), the human resource system table (145), the external database table (146), the advanced finance system table (147) and the soft asset system table (148). The attributes calculated in this step include: cumulative total value, the period-to-period rate of change in value, the rolling average value and a series of time lagged values. In a similar fashion the software in block 293 calculates attributes for each date field in the specified tables including time since last occurrence, cumulative time since first occurrence, average frequency of occurrence and the rolling average frequency of occurrence. The numbers derived from numeric and date fields are collectively referred to as “item performance indicators”. The software in block 293 also calculates pre-specified combinations of variables called composite variables for measuring the strength of the different elements of value. The item performance indicators are stored in the table where the item source data was obtained and the composite variables are stored in the composite variables table (153) before processing advances to a block 294.

The software in block 294 uses attribute derivation algorithms such as the AQ program to create combinations of the variables that weren't pre-specified for combination. While the AQ program is used in the preferred embodiment of the present invention, other attribute derivation algorithms such as the LINUS algorithms, may be used to the same effect. The software creates these attributes using both item variables that were specified as “element” variables and item variables that were not. The resulting composite variables are stored in the composite variables table (153) before processing advances to a block 295.

The software in block 295 derives market value factors by enterprise for each numeric data field with data in the sentiment factor table (169). Market value factors include: the ratio of enterprise earnings to expected earnings, inflation rate, growth in g.d.p., volatility, volatility vs. industry average volatility, interest rates, increases in interest rates, consumer confidence and the unemployment rate that have an impact on the market price of the equity for an enterprise and/or an industry. The market value factors derived in this step include: cumulative totals, the period to period rate of change, the rolling average value and a series of time lagged values. In a similar fashion the software in block 295 calculates market value factors for each date field in the specified table including time since last occurrence, cumulative time since first occurrence, average frequency of occurrence and the rolling average frequency of occurrence. The numbers derived from numeric and date fields are collectively referred to as “market performance indicators”. The software in block 295 also calculates pre-specified combinations of variables called composite factors for measuring the strength of the different market value factors. The market performance indicators and the composite factors are stored in the sentiment factor table (169) before processing advances to a block 296.

The software in block 296 uses attribute derivation algorithms such as the Linus algorithm to create combinations of the factors that were not pre-specified for combination. While the Linus algorithm is used in the preferred embodiment of the present invention, other attribute derivation algorithms such as the AQ program may be used to the same effect. The software creates these attributes using both market value factors that were included in “composite factors” and market value factors that were not. The resulting composite variables are stored in the sentiment factors table (169) before processing advances to a block 297.

The software in block 297 uses pattern-matching algorithms to assign pre-designated data fields for different elements of value to pre-defined groups with numerical values. This type of analysis is useful in classifying purchasing patterns and/or communications patterns as “heavy”, “light”, “moderate” or “sporadic”. The classification and the numeric value associated with the classification are stored in the application database (50) table where the data field is located before processing advances to a block 298.

The software in block 298 retrieves data from the metadata mapping table (141), creates and then stores the definitions for the pre-defined components of value in the components of value definition table (155). As discussed previously, the revenue component of value is not divided into sub-components, the expense component is divided into five sub-components (the cost of raw materials, the cost of manufacture or delivery of service, the cost of selling, the cost of support and the cost of administration) and the capital change component is divided into six sub-components: (cash, non-cash financial assets, production equipment, other assets, financial liabilities and equity) in the preferred embodiment. An analysis of cash flow, which is essentially revenue minus expense plus capital change can be substituted for the more detailed analysis of the revenue, expense and capital components. Different subdivisions of the components of value can also be used to the same effect. When data storage is complete, processing advances to a software block 302 to begin the analysis of the extracted data using analysis bots.

### Analysis Bots

The flow diagrams in FIG. 6A, FIG. 6B and FIG. 6C detail the processing that is completed by the portion of the application software (300) that programs analysis bots to:

1. Identify the item variables, item performance indicators and/or composite variables for each enterprise, element of value and sub-element of value that drive the components of value (revenue, expense and changes in capital);

2. Create vectors that use item variables, item performance indicators and/or composite variables to summarize the performance of each enterprise, element of value and sub-element of value;

3. Determine the appropriate cost of capital on the basis of relative causal element strength and value the enterprise real options;

4. Determine the expected life of each element of value and sub-element of value;

5. Calculate the enterprise current operation value and value the revenue, expense and capital components for said current operations using the information prepared in the previous stage of processing;

6. Specify and optimize predictive causal models to determine the relationship between the vectors determined in step 2 and the revenue, expense and capital values determined in step 5;

7. Combine the results of the fourth, fifth, and sixth stages of processing to determine the value of each, element and sub-element (as shown in Table 5);

8. Calculate the market sentiment by subtracting the current operation value, the total value of real options and the allocated industry options from market value for the enterprise (if it has a public stock market price); and

9. Analyze the sources of market sentiment.

Each analysis bot generally normalizes the data being analyzed before processing begins.

Processing in this portion of the application begins in software block 302. The software in block 302 checks the system settings table (140) in the application database (50) to determine if the current calculation is a new calculation or a structure change. If the calculation is not a new calculation or a structure change then processing advances to a software block 323. Alternatively, if the calculation is new or a structure change, then processing advances to a software block 303.

The software in block 303 retrieves data from the meta data mapping table (141) and the soft asset system table (148) and then assigns item variables, item performance indicators and composite variables to each element of value using a two step process. First, item variables and item performance indicators are assigned to elements of value based on the soft asset management system they correspond to (for example, all item variables from a brand management system and all item performance indicators derived from brand management system variables are assigned to the brand element of value). Second, pre-defined composite variables are assigned to the element of value they were assigned to measure in the metadata mapping table (141). After the assignment of variables and indicators to elements is complete, the resulting assignments are saved to the element of value definition table (155) and processing advances to a block 304.

The software in block 304 checks the bot date table (149) and deactivates any temporal clustering bots with creation dates before the current system date. The software in block 304 then initializes bots as required for each component of value. The bots activate in accordance with the frequency specified by the user (20) in the system settings table (140), retrieve the information from the system settings table (140), the metadata mapping table (141) and the component of value definition table (156) as required and define segments for the component of value data before saving the resulting cluster information in the application database (50).

Bots are independent components of the application that have specific tasks to perform. In the case of temporal clustering bots, their primary task is to segment the component and sub-component of value variables into distinct time regimes that share similar characteristics. The temporal clustering bot assigns a unique id number to each “regime” it identifies and stores the unique id numbers in the cluster id table (157). Every time period with data is assigned to one of the regimes. The cluster id for each regime is saved in the data record for each item variable in the table where it resides. The item variables are segmented into a number of regimes less than or equal to the maximum specified by the user (20) in the system settings. The data are segmented using a competitive regression algorithm that identifies an overall, global model before splitting the data and creating new models for the data in each partition. If the error from the two models is greater than the error from the global model, then there is only one regime in the data. Alternatively, if the two models produce lower error than the global model, then a third model is created. If the error from three models is lower than from two models then a fourth model is added. The process continues until adding a new model does not improve accuracy. Other temporal clustering algorithms may be used to the same effect. Every temporal clustering bot contains the information shown in Table 21.

TABLE 21

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Maximum number of clusters |
| 6. | Variable 1 |
| . . . | to |
| 6 + n. | Variable n |

When bots in block 304 have identified and stored regime assignments for all time periods with data, processing advances to a software block 305.

The software in block 305 checks the bot date table (149) and deactivates any variable clustering bots with creation dates before the current system date. The software in block 305 then initializes bots as required for each element of value. The bots activate in accordance with the frequency specified by the user (20) in the system settings table (140), retrieve the information from the system settings table (140), the metadata mapping table (141) and the element of value definition table (155) as required and define segments for the element of value data before saving the resulting cluster information in the application database (50).

Bots are independent components of the application that have specific tasks to perform. In the case of variable clustering bots, their primary task is to segment the element of value variables into distinct clusters that share similar characteristics. The clustering bot assigns a unique id number to each “cluster” it identifies and stores the unique id numbers in the cluster id table (157). Every item variable for every element of value is assigned to one of the unique clusters. The cluster id for each variable is saved in the data record for each item variable in the table where it resides. The item variables are segmented into a number of clusters less than or equal to the maximum specified by the user (20) in the system settings. The data are segmented using the “default” clustering algorithm the user (20) specified in the system settings. The system of the present invention provides the user (20) with the choice of several clustering algorithms including: an unsupervised “Kohonen” neural network, neural network, decision tree, support vector method, K-nearest neighbor, expectation maximization (EM) and the segmental K-means algorithm. For algorithms that normally require the number of clusters to be specified, the bot will iterate the number of clusters until it finds the cleanest segmentation for the data. Every variable clustering bot contains the information shown in Table 22.

TABLE 22

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Element of value |
| 6. | Clustering algorithm type |
| 7. | Maximum number of clusters |
| 8. | Variable 1 |
| . . . | to |
| 8 + n. | Variable n |

When bots in block 305 have identified and stored cluster assignments for the item variables associated with each component and subcomponent of value, processing advances to a software block 306.

The software in block 306 checks the bot date table (149) and deactivates any predictive model bots with creation dates before the current system date. The software in block 306 then retrieves the information from the system settings table (140), the metadata mapping table (141), the element of value definition table (155) and the component of value definition table (156) required to initialize predictive model bots for each component of value.

Bots are independent components of the application that have specific tasks to perform. In the case of predictive model bots, their primary task is to determine the relationship between the item variables, item performance indicators and/or composite variables (collectively hereinafter, “the variables”) and the components of value (and sub-components of value). Predictive model bots are initialized for each component and sub-component of value. They are also initialized for each cluster and regime of data in accordance with the cluster and regime assignments specified by the bots in blocks 304 and 305. A series of predictive model bots are initialized at this stage because it is impossible to know in advance which predictive model type will produce the “best” predictive model for the data from each commercial enterprise. The series for each model includes 12 predictive model bot types: neural network; CART; GARCH, projection pursuit regression; generalized additive model (GAM); redundant regression network; rough-set analysis; boosted Naive Bayes Regression; MARS; linear regression; support vector method and stepwise regression. Additional predictive model types can be used to the same effect. The software in block 306 generates this series of predictive model bots for the levels of the enterprise shown in Table 23.

TABLE 23
Predictive models by enterprise level

Enterprise:
Element variables relationship to enterprise revenue component of value
Element variables relationship to enterprise expense subcomponents of
value
Element variables relationship to enterprise capital change subcomponents
of value
Element of Value:
Sub-element of value variables relationship to element of value

Every predictive model bot contains the information shown in Table 24.

TABLE 24

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Component or subcomponent of value |
| 6. | Global or Cluster (ID) and/or Regime (ID) |
| 7. | Element or Sub-Element ID |
| 8. | Predictive Model Type |
| 9. | Variable 1 |
| . . . | to |
| 9 + n. | Variable n |

After predictive model bots are initialized, the bots activate in accordance with the frequency specified by the user (20) in the system settings table (140). Once activated, the bots retrieve the required data from the appropriate table in the application database (50) and randomly partition the item variables, item performance indicators and composite variables into a training set and a test set. The software in block 306 uses “bootstrapping” where the different training data sets are created by re-sampling with replacement from the original training set, so data records may occur more than once. The same sets of data will be used to train and then test each predictive model bot. When the predictive model bots complete their training and testing, processing advances to a block 307.

The software in block 307 determines if clustering improved the accuracy of the predictive models generated by the bots in software block 306. The software in block 307 uses a variable selection algorithm such as stepwise regression (other types of variable selection algorithms can be used) to combine the results from the predictive model bot analyses for each type of analysis—with and without clustering—to determine the best set of variables for each type of analysis. The type of analysis having the smallest amount of error as measured by applying the mean squared error algorithm to the test data is given preference in determining the best set of variables for use in later analysis. There are four possible outcomes from this analysis as shown in Table 25.

TABLE 25

| | |
|---|---|
| 1. | Best model has no clustering |
| 2. | Best model has temporal clustering, no variable clustering |
| 3. | Best model has variable clustering, no temporal clustering |
| 4. | Best model has temporal clustering and variable clustering |

If the software in block 307 determines that clustering improves the accuracy of the predictive models, then processing advances to a software block 310. Alternatively, if clustering doesn't improve the overall accuracy of the predictive models, then processing advances to a software block 308.

The software in block 308 uses a variable selection algorithm such as stepwise regression (other types of variable selection algorithms can be used) to combine the results from the predictive model bot analyses for each model to determine the best set of variables for each model. The models having the smallest amount of error as measured by applying the mean squared error algorithm to the test data are given preference in determining the best set of variables. As a result of this processing, the best set of variables contain: the item variables, item performance indicators and/or composite variables that correlate most strongly with changes in the components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected and stored in the element variables table (158) for all models at all levels, the software in block 308 tests the independence of the value drivers at the enterprise, element and sub-element level before processing advances to a block 309.

The software in block 309 checks the bot date table (149) and deactivates any causal model bots with creation dates before the current system date. The software in block 309 then retrieves the information from the system settings table (140), the metadata mapping table (141), the component of value definition table (156) and the element variables table (158) as required to initialize causal model bots for each enterprise, element of value and sub-element of value in accordance with the frequency specified by the user (20) in the system settings table (140).

Bots are independent components of the application that have specific tasks to perform. In the case of causal model bots, their primary task is to refine the item variable, item performance indicator and composite variable selection to reflect only causal variables. (Note: these variables are grouped together to represent an element vector when they are dependent). A series of causal model bots are initialized at this stage because it is impossible to know in advance which causal model will produce the “best” vector for the best fit variables from each model. The series for each model includes five causal model bot types: Tetrad, MML, LaGrange, Bayesian and path analysis. The software in block 309 generates this series of causal model bots for each set of variables stored in the element variables table (158) in the previous stage in processing. Every causal model bot activated in this block contains the information shown in Table 26.

TABLE 26

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Component or subcomponent of value |
| 6. | Enterprise, Element or Sub-Element ID |
| 7. | Variable Set |
| 8. | Causal model type |

After the causal model bots are initialized by the software in block 309, the bots activate in accordance with the frequency specified by the user (20) in the system settings table (140). Once activated, they retrieve the element variable information for each model from the element variables table (158) and sub-divides the variables into two sets, one for training and one for testing. The same set of training data is used by each of the different types of bots for each model. After the causal model bots complete their processing for each model, the software in block 309 uses a model selection algorithm to identify the model that best fits the data for each enterprise, element or sub-element being analyzed. For the system of the present invention, a cross validation algorithm is used for model selection. The software in block 309 saves the best fit causal factors in the vector table (159) in the application database (50) and processing advances to a block 312. The software in block 312 tests the value drivers or vectors to see if there are “missing” value drivers that are influencing the results. If the software in block 312 does not detect any missing value drivers, then system processing advances to a block 323. Alternatively, if missing value drivers are detected by the software in block 312, then processing advances to a software block 321.

If software in block 307 determines that clustering improves predictive model accuracy, then processing advances to block 310 as described previously. The software in block 310 uses a variable selection algorithm such as stepwise regression (other types of variable selection algorithms can be used) to combine the results from the predictive model bot analyses for each model and cluster to determine the best set of variables for each model. The models having the smallest amount of error as measured by applying the mean squared error algorithm to the test data are given preference in determining the best set of variables. As a result of this processing, the best set of variables contain: the item variables, item performance indicators and composite variables that correlate most strongly with changes in the components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected and stored in the element variables table (158) for all models at all levels, the software in block 310 tests the independence of the value drivers at the enterprise, element and sub-element level before processing advances to a block 311.

The software in block 311 checks the bot date table (149) and deactivates any causal model bots with creation dates before the current system date. The software in block 311 then retrieves the information from the system settings table (140), the metadata mapping table (141), the component of value definition table (156) and the element variables table (158) as required to initialize causal model bots for each enterprise, element of value and sub-element of value at every level in accordance with the frequency specified by the user (20) in the system settings table (140).

Bots are independent components of the application that have specific tasks to perform. In the case of causal model bots, their primary task is to refine the item variable, item performance indicator and composite variable selection to reflect only causal variables. (Note: these variables are grouped together to represent a single element vector when they are dependent). In some cases it may be possible to skip the correlation step before selecting causal the item variable, item performance indicator and composite variables. A series of causal model bots are initialized at this stage because it is impossible to know in advance which causal model will produce the “best” vector for the best fit variables from each model. The series for each model includes four causal model bot types: Tetrad, LaGrange, Bayesian and path analysis. The software in block 311 generates this series of causal model bots for each set of variables stored in the element variables table (158) in the previous stage in processing. Every causal model bot activated in this block contains the information shown in Table 27.

TABLE 27

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Component or subcomponent of value |
| 6. | Cluster (ID) and/or Regime (ID) |
| 7. | Element or Sub-Element ID |
| 8. | Variable set |
| 9. | Causal model type |

After the causal model bots are initialized by the software in block 311, the bots activate in accordance with the frequency specified by the user (20) in the system settings table (140). Once activated, they retrieve the element variable information for each model from the element variables table (158) and sub-divides the variables into two sets, one for training and one for testing. The same set of training data is used by each of the different types of bots for each model. After the causal model bots complete their processing for each model, the software in block 311 uses a model selection algorithm to identify the model that best fits the data for each enterprise, element or sub-element being analyzed. For the system of the present invention, a cross validation algorithm is used for model selection. The software in block 311 saves the best fit causal factors in the vector table (159) in the application database (50) and processing advances to a block 312. The software in block 312 tests the value drivers or vectors to see if there are “missing” value drivers that are influencing the results. If the software in block 312 doesn't detect any missing value drivers, then system processing advances to a block 323. Alternatively, if missing value drivers are detected by the software in block 312, then processing advances to a software block 321.

The software in block 321 prompts the user (20) via the variable identification window (710) to adjust the specification(s) for the affected enterprise, element of value or subelement of value. After the input from the user (20) is saved in the system settings table (140) and/or the element of value definition table (155), system processing advances to a software block 323. The software in block 323 checks the system settings table (140) and/or the element of value definition table (155) to see if there any changes in structure. If there have been changes in the structure, then processing advances to a block 205 and the system processing described previously is repeated. Alternatively, if there are no changes in structure, then processing advances to a block 325.

The software in block 325 checks the system settings table (140) in the application database (50) to determine if the current calculation is a new one. If the calculation is new or a structure change, then processing advances to a software block 333. Alternatively, if the calculation is not a new calculation, then processing advances to a software block 326.

The software in block 326 checks the bot date table (149) and deactivates any vector generation bots with creation dates before the current system date. The software in block 326 then initializes bots for each element and sub-element of value for the enterprise. The bots activate in accordance with the frequency specified by the user (20) in the system settings table (140), retrieve the information from the system settings table (140), the metadata mapping table (141) the component of value definition table (156) and the element variables table (158) as required to initialize vector generation bots for each enterprise, element of value and sub-element of value in accordance with the frequency specified by the user (20) in the system settings table (140).

Bots are independent components of the application that have specific tasks to perform. In the case of vector generation bots, their primary task is to produce formulas, (hereinafter, vectors) that summarize the relationship between the item variables, item performance indicators and/or composite variables for the element or sub-element and changes in the component or sub-component of value being examined. (Note: these variables are simply grouped together to represent an element vector when they are dependent). A series of vector generation bots are initialized at this stage because it is impossible to know in advance which vector generation algorithm will produce the “best” vector for the best fit variables from each model. The series for each model includes three vector generation bot types: data fusion, polynomial and LaGrange. The software in block 326 generates this series of vector generation bots for each set of variables stored in the element variables table (158). Every vector generation bot contains the information shown in Table 28.

TABLE 28

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Maximum number of regimes |
| 6. | Enterprise or Industry |
| 7. | Factor 1 |
| . . . | to |
| 7 + n. | Factor n |

When bots in block 326 have identified and stored vectors for all time periods with data, processing advances to a software block 327.

The software in block 327 checks the bot date table (149) and deactivates any temporal clustering bots with creation dates before the current system date. The software in block 327 then initializes bots for market value factors for each enterprise with a market price and for the industry. The bots activate in accordance with the frequency specified by the user (20) in the system settings table (140), retrieve the information from the system settings table (140), the metadata mapping table (141) and the sentiment factor table (169) as required and define regimes for the market value factor data before saving the resulting regime information in the application database (50).

Bots are independent components of the application that have specific tasks to perform. In the case of temporal clustering bots for market value factors, their primary tasks are to identify the best market value indicator, price, relative price, yield or first derivative of price change to use for market factor analysis and then to segment the market value factors into distinct time regimes that share similar characteristics. The temporal clustering bots select the best value indicator by grouping the universe of stocks using each of the four value indicators and then comparing the clusters to the known groupings of the S&P 500. The value indicator could optionally be specified by the user (20). The temporal clustering bots then use the identified value indicator in the analysis of temporal clustering. The bots assign a unique id number to each “regime” it identifies and stores the unique id numbers in the cluster id table (157) every time period with data is assigned to one of the regimes. The cluster id for each regime is also saved in the data record for each market value factor in the table where it resides. The market value factors are segmented into a number of regimes less than or equal to the maximum specified by the user (20) in the system settings. The factors are segmented using a competitive regression algorithm that identifies an overall, global model before splitting the data and creating new models for the data in each partition. If the error from the two models is greater than the error from the global model, then there is only one regime in the data. Alternatively, if the two models produce lower error than the global model, then a third model is created. If the error from three models is lower than from two models then a fourth model is added. The process continues until adding a new model does not improve accuracy. Other temporal clustering algorithms may be used to the same effect. Every temporal clustering bot contains the information shown in Table 29.

TABLE 29

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Maximum number of regimes |
| 6. | Enterprise or Industry |
| 7. | Value indicator (price, relative price, yield, derivative, etc.) |
| 8. | Factor 1 |
| . . . | to |
| 8 + n. | Factor n |

When bots in block 327 have identified and stored regime assignments for all time periods with data, processing advances to a software block 328.

The software in block 328 checks the bot date table (149) and deactivates any causal factor bots with creation dates before the current system date. The software in block 328 then retrieves the information from the system settings table (140), the metadata mapping table (141), the element of value definition table (155) and the sentiment factors table (169) as required to initialize causal market value factor bots for the enterprise and for the industry in accordance with the frequency specified by the user (20) in the system settings table (140).

Bots are independent components of the application that have specific tasks to perform. In the case of causal factor bots, their primary task is to identify the item variables, item performance indicators, composite variables and/or market value factors that are causal factors for stock price movement. (Note: these variables are grouped together when they are dependent). For each enterprise and industry the causal factors are those that drive changes in the value indicator identified by the temporal clustering bots. A series of causal factor bots are initialized at this stage because it is impossible to know in advance which causal factors will produce the “best” model for each enterprise and industry. The series for each model includes five causal model bot types: Tetrad, LaGrange, MML, Bayesian and path analysis. Other causal models can be used to the same effect. The software in block 328 generates this series of causal model bots for each set of variables stored in the element variables table (158) in the previous stage in processing. Every causal factor bot activated in this block contains the information shown in Table 30.

TABLE 30

| | |
|---|---|
| 1. | Unique ID number (based on date, hour, minute, second of creation) |
| 2. | Creation date (date, hour, minute, second) |
| 3. | Mapping information |
| 4. | Storage location |
| 6. | Enterprise or Industry |
| 7. | Regime |
| 8. | Value indicator (price, relative price, yield, derivative, etc.) |
| 9. | Causal model type |

After the causal factor bots are initialized by the software in block 328, the bots activate in accordance with the frequency specified by the user (20) in the system settings table (140). Once activated, they retrieve the required information from the element of value definition table (155) and the sentiment factor table (169) and sub-divide the data into two sets, one for training and one for testing. The same set of training data is used by each of the different types of bots for each model. After the causal factor bots complete their processing for the enterprise and/or industry, the software in block 328 uses a model selection algorithm to identify the model that best fits the data for each enterprise or industry. For the system of the present invention, a cross validation algorithm is used for model selection. The software in block 328 saves the best fit causal factors in the sentiment factors table (169) in the application database (50) and processing advances to a block 329. The software in block 329 tests to see if there are “missing” causal market value factors that are influencing the results. If the software in block 329 does not detect any missing market value factors, then system processing advances to a block 330. Alternatively, if missing market value factors are detected by the software in block 329, then processing returns to software block 321 and the processing described in the preceding section is repeated.

The software in block 330 checks the bot date table (149) and deactivates any industry rank bots with creation dates before the current system date. The software in block 330 then retrieves the information from the system settings table (140), the metadata mapping table (141), the vector table (159) and the sentiment factors table (169) as required to initialize industry rank bots for the enterprise if it has a public stock market price and for the industry in accordance with the frequency specified by the user (20) in the system settings table (140).

Bots are independent components of the application that have specific tasks to perform. In the case of industry rank bots, their primary task is to determine the relative position of the enterprise being evaluated on the causal attributes identified in the previous processing step. (Note: these variables are grouped together when they are dependent). The industry rank bots use Data Envelopement Analysis (hereinafter, DEA) to determine the relative industry ranking of the enterprise being examined. The software in block 330 generates industry rank bots for the enterprise being evaluated. Every industry rank bot activated in this block contains the information shown in Table 31.

TABLE 31
1. Unique ID number (based on date, hour, minute, second of creation)
2. Creation date (date, hour, minute, second)
3. Mapping information
4. Storage location
5. Enterprise

After the industry rank bots are initialized by the software in block 330, the bots activate in accordance with the frequency specified by the user (20) in the system settings table (140). Once activated, they retrieve the item variables, item performance indicators, composite variables and/or market value factors for the enterprise from the application database (50) and sub-divides the factors into two sets, one for training and one for testing. After the industry rank bots complete their processing for the enterprise the software in block 330 saves the industry ranks in the vector table (159) in the application database (50) and processing advances to a block 331. The software in block 331 checks the bot date table (149) and deactivates any option bots with creation dates before the current system date. The software in block 331 then retrieves the information from the system settings table (140), the metadata mapping table (141), the basic financial system database (143), the external database table (146) and the advanced finance system table (147) as required to initialize option bots for the industry and the enterprise.

Bots are independent components of the application that have specific tasks to perform. In the case of option bots, their primary tasks are to calculate the discount rate to be used for valuing the real options and to value the real options for the industry and the enterprise. The discount rate for enterprise real options is calculated by adding risk factors for each causal soft asset to a base discount rate. The risk factor for each causal soft asset is determined by a two step process. The first step in the process divides the maximum real option discount rate (specified by the user in system settings) by the number of causal soft assets. The second step in the process determines if the enterprise is highly rated on the causal soft assets and also determines an appropriate risk factor. If the enterprise is highly ranked on the soft asset, then the discount rate is increased by a relatively small amount for that causal soft asset. Alternatively, if the enterprise has a low rating on a causal soft asset, then the discount rate is increased by a relatively large amount for that causal soft asset as shown below in Table 32.

TABLE 32
Maximum discount rate = 50%, Causal soft assets = 5
Maximum risk factor/soft asset = 50%/5 = 10%

| Industry Rank on Soft Asset | % of Maximum |
|---|---|
| 1 | 0% |
| 2 | 25% |
| 3 | 50% |
| 4 | 75% |
| 5 or higher | 100% |

| Causal Soft Asset: | Relative Rank | Risk Factor |
|---|---|---|
| Brand | 1 | 0% |
| Channel | 3 | 5% |
| Manufacturing Process | 4 | 7.5% |
| Strategic Alliances | 5 | 10% |
| Vendors | 2 | 2.5% |
| Subtotal | | 25% |
| Base Rate | | 12% |
| Discount Rate | | 37% |

The discount rate for industry options is calculated using a traditional total cost of capital approach in a manner that is well known. After the appropriate discount rates are determined, the value of each real option is calculated using Black Scholes algorithms in a manner that is well known. The real option can be valued using other algorithms including binomial, neural network or dynamic programming algorithms. The software in block 331 values option bots for the industry and the enterprise. Industry option bots utilize the industry cost of capital for all calculations.

Option bots contain information shown in Table 33.

TABLE 33
1. Unique ID number (based on date, hour, minute, second of creation)
2. Creation date (date, hour, minute, second)
3. Mapping information
4. Storage location
5. Industry or Enterprise ID
6. Real option type (Industry or Enterprise)
7. Real option
8. Allocation percentage (if applicable)

After the option bots are initialized, they activate in accordance with the frequency specified by the user (20) in the system settings table (140). After being activated, the bots retrieve information for the industry and the enterprise from the basic financial system database (143), the external database table (146) and the advanced finance system table (147) as required to complete the option valuation. After the discount has been determined, the value of the real option is calculated using Black Schole's algorithms in a manner that is well known. The resulting values are then saved in the real option value table (162) in the application database (50) before processing advances to a block 332.

The software in block 332 uses the results of the DEA analysis in the prior processing block and the percentage of industry real options controlled by the enterprise to determine the allocation percentage for industry options. The more dominant the enterprise, as indicated by the industry rank for the intangible element indicators, the greater the allocation of industry real options. When the allocation of options has been determined and the resulting values stored in the real option value table (162) in the application database (50), processing advances to a block 333.

The software in block 333 checks the system settings table (140) in the application database (50) to determine if the current calculation is a new calculation or a structure change. If the calculation is not a new calculation, a value analysis or a structure change, then processing advances to a software block 341. Alternatively, if the calculation is new, a value analysis or a structure change, then processing advances to a software block 343.

The software in block 341 checks the bot date table (149) and deactivates any cash flow bots with creation dates before the current system date. The software in the block then retrieves the information from the system settings table (140), the metadata mapping table (141) and the component of value definition table (156) as required to initialize cash flow bots for the enterprise in accordance with the frequency specified by the user (20) in the system settings table (140).

Bots are independent components of the application that have specific tasks to perform. In the case of cash flow bots, their primary tasks are to calculate the cash flow for the enterprise for every time period where data is available and to forecast a steady state cash flow for the enterprise. Cash flow is calculated using a well known formula where cash flow equals period revenue minus period expense plus the period change in capital plus non-cash depreciation/amortization for the period. The steady state cash flow is calculated for the enterprise using forecasting methods identical to those disclosed previously in U.S. Pat. No. 5,615,109 to forecast revenue, expenses, capital changes and depreciation separately before calculating the cash flow. The software in block 341 initializes cash flow bots for the enterprise.

Every cash flow bot contains the information shown in Table 34.

TABLE 34
1. Unique ID number (based on date, hour, minute, second of creation)
2. Creation date (date, hour, minute, second)
3. Mapping information
4. Storage location
5. Enterprise ID
6. Components of value

After the cash flow bots are initialized, the bots activate in accordance with the frequency specified by the user (20) in the system settings table (140). After being activated the bots retrieve the component of value information for the enterprise from the component of value definition table (156). The cash flow bots then complete the calculation and forecast of cash flow for the enterprise before saving the resulting values by period in the cash flow table (161) in the application database (50) before processing advances to a block 342.

The software in block 342 checks the bot date table (149) and deactivates any element life bots with creation dates before the current system date. The software in block 342 then retrieves the information from the system settings table (140), the metadata mapping table (141) and the element of value definition table (155) as required to initialize element life bots for each element and sub-element of value in the enterprise being examined.

Bots are independent components of the application that have specific tasks to perform. In the case of element life bots, their primary task is to determine the expected life of each element and sub-element of value. There are three methods for evaluating the expected life of the elements and sub-elements of value. Elements of value that are defined by a population of members or items (such as: channel partners, customers, employees and vendors) will have their lives estimated by analyzing and forecasting the lives of the members of the population. The forecasting of member lives will be determined by the “best” fit solution from competing life estimation methods including the Iowa type survivor curves, Weibull distribution survivor curves, Gompertz-Makeham survivor curves, polynomial equations and the forecasting methodology disclosed in U.S. Pat. No. 5,615,109. Elements of value (such as some parts of Intellectual Property, i.e. patents) that have legally defined lives will have their lives calculated using the time period between the current date and the expiration date of the element or sub-element. Finally, elements of value and sub-element of value (such as brand names, information technology and processes) that may not have defined lives and that may not consist of a collection of members will have their lives estimated by comparing the relative strength and stability of the element vectors with the relative stability of the enterprise Competitive Advantage Period (CAP) estimate. The resulting values are stored in the element of value definition table (155) for each element and sub-element of value.

Every element life bot contains the information shown in Table 35.

TABLE 35
1. Unique ID number (based on date, hour, minute, second of creation)
2. Creation date (date, hour, minute, second)
3. Mapping information
4. Storage location
5. Element of Sub-Element of value
6. Life estimation method (item analysis, date calculation or relative CAP)

After the element life bots are initialized, they are activated in accordance with the frequency specified by the user (20) in the system settings table (140). After being activated, the bots retrieve information for each element and sub-element of value from the element of value definition table (155) as required to complete the estimate of element life. The resulting values are then saved in the element of value definition table (155) in the application database (50) before processing advances to a block 343.

The software in block 343 checks the system settings table (140) in the application database (50) to determine if the current calculation is a new calculation, a value analysis or a structure change. If the calculation is not a new calculation or a structure change, then processing advances to a software block 402. Alternatively, if the calculation is new, a value analysis or a structure change, then processing advances to a software block 345.

The software in block 345 checks the bot date table (149) and deactivates any component capitalization bots with creation dates before the current system date. The software in block 345 then retrieves the information from the system settings table (140), the metadata mapping table (141) and the component of value definition table (156) as required to initialize component capitalization bots.

Bots are independent components of the application that have specific tasks to perform. In the case of component capitalization bots, their task is to determine the capitalized value of the components and subcomponents of value, forecast revenue, expense or capital requirements for the enterprise in accordance with the formula shown in Table 36.

TABLE 36
Value = F_{f1}/(1 + K) + F_{f2}/
(1 + K)² + F_{f3}/(1 + K)³ +
F_{f4}/(1 + K)⁴ + (F_{f4} ×
(1 + g))/(1 + K)⁵) +
(F_{f4} × (1 + g)²)/
(1 + K)⁶). . . + (F_{f4} × (1 + g)^{N})/
(1 + K)^{N+4})

| | | |
|---|---|---|
| Where: | | |
| F_{fx} | = | Forecast revenue, expense or capital requirements for year x |
| | | after valuation date (from advanced financial system) |
| N | = | Number of years in CAP (from prior calculation) |
| K | = | Cost of capital - % per year (from prior calculation) |
| g | = | Forecast growth rate during CAP - |
| | | % per year (from advanced |
| | | financial system) |

After the calculation of the capitalized value of every component and sub-component of value is complete, the results are stored in the component of value definition table (156) in the application database (50).

Every component capitalization bot contains the information shown in Table 37.

TABLE 37
1. Unique ID number (based on date, hour, minute, second of creation)
2. Creation date (date, hour, minute, second)
3. Mapping information
4. Storage location
5. Enterprise ID
6. Component of Value (Revenue, Expense or Capital Change)
7. Sub Component of Value

After the component capitalization bots are initialized they activate in accordance with the frequency specified by the user (20) in the system settings table (140). After being activated, the bots retrieve information for each component and sub-component of value from the advanced finance system table (147) and the component of value definition table (156) as required to calculate the capitalized value of each component. The resulting values are then saved in the component of value definition table (156) in the application database (50) before processing advances to a block 347.

The software in block 347 checks the bot date table (149) and deactivates any element valuation bots with creation dates before the current system date. The software in block 347 then retrieves the information from the system settings table (140), the metadata mapping table (141), the element of value definition table (155) and the component of value definition table (156) as required to initialize valuation bots for each element and sub-element of value.

Bots are independent components of the application that have specific tasks to perform. In the case of element valuation bots, their task is to calculate the contribution of every element of value and sub-element of value in the enterprise using the overall procedure outlined in Table 5. As a simplification, the bots could of course check the contribution of every element to enterprise cash flow, however, this would not provide as much detail as the method contained in the preferred embodiment. The first step in completing the calculation in accordance with the procedure outlined in Table 5 is determining the relative contribution of element and sub-element of value by using a series of predictive models to find the best fit relationship between:

1. The element of value vectors and the enterprise components of value, and

2. The sub-element of value vectors and the element of value they correspond to.

The system of the present invention uses 12 different types of predictive models to determine relative contribution: neural network; CART; projection pursuit regression; generalized additive model (GAM); GARCH; MMDR, redundant regression network; boosted Naive Bayes Regression; the support vector method; MARS; linear regression; and stepwise regression to determine relative contribution. The model having the smallest amount of error as measured by applying the mean squared error algorithm to the test data is the best fit model. The “relative contribution algorithm” used for completing the analysis varies with the model that was selected as the “best-fit”. For example, if the “best-fit” model is a neural net model, then the portion of revenue attributable to each input vector is determined by the formula shown in Table 38.

TABLE 38
$( {\sum }_{k = 1}^{k = m} {\sum }_{j = 1}^{j = n} {I}_{jk} \times {O}_{k} / {\sum }_{j = 1}^{j = n} {I}_{ik} ) / {\sum }_{k = 1}^{k = m} {\sum }_{j = 1}^{j = n} {I}_{jk} \times {O}_{k}$

| | |
|---|---|
| Where | |
| Iⱼₖ | = Absolute value of the input weight from input node |
| | j to hidden node k |
| Oₖ | = Absolute value of output weight from hidden node k |
| m | = number of hidden nodes |
| n | = number of input nodes |

After the relative contribution of each enterprise, element of value and sub-element of value is determined, the results of this analysis are combined with the previously calculated information regarding element life and capitalized component value to complete the valuation of each element of value and sub-element using the approach shown in Table 39.

TABLE 39

| | | Element | |
|---|---|---|---|
| Gross Value | Percentage | Life/CAP | Net Value |
| Revenue value = $120M | 20% | 80% | Value = $19.2M |
| Expense value = ($80M) | 10% | 80% | Value = ($6.4)M |
| Capital value = ($5M) | 5% | 80% | Value = ($0.2)M |
| Total value = $35M | | | |
| Net value for this element: | | | Value = $12.6M |

The resulting values are stored in the element of value definition table (155) for each element and sub-element of value of the enterprise.

Every valuation bot contains the information shown in Table 40.

TABLE 40
1. Unique ID number (based on date, hour, minute, second of creation)
2. Creation date (date, hour, minute, second)
3. Mapping information
4. Storage location
5. Element of Value or Sub-Element of Value
6. Element of Value ID

After the valuation bots are initialized by the software in block 347 they activate in accordance with the frequency specified by the user (20) in the system settings table (140). After being activated, the bots retrieve information from the element of value definition table (155) and the component of value definition table (156) as required to complete the valuation. The resulting values are then saved in the element of value definition table (155) in the application database (50) before processing advances to a block 351.

The software in block 351 checks the bot date table (149) and deactivates any residual bots with creation dates before the current system date. The software in block 351 then retrieves the information from the system settings table (140), the metadata mapping table (141) and the element of value definition table (155) as required to initialize residual bots for the enterprise.

Bots are independent components of the application that have specific tasks to perform. In the case of residual bots, their task is to retrieve data as required from the element of value definition table (155) and the component of value definition table (156) and then calculate the residual going concern value for the enterprise in accordance with the formula shown in Table 41.

TABLE 41
Residual Going Concern Value = Total Current-Operation Value −
Σ Financial Asset Values − Σ Elements of Value

Every residual bot contains the information shown in Table 42.

TABLE 42
1. Unique ID number (based on date, hour, minute, second of creation)
2. Creation date (date, hour, minute, second)
3. Mapping information
4. Storage location
5. Enterprise ID

After the residual bots are initialized they activate in accordance with the frequency specified by the user (20) in the system settings table (140). After being activated, the bots retrieve information from the element of value definition table (155) and the component of value definition table (156) as required to complete the residual calculation for the enterprise. After the calculation is complete, the resulting values are then saved in the element of value definition table (155) in the application database (50) before processing advances to a block 352.

The software in block 352 checks the bot date table (149) and deactivates any sentiment calculation bots with creation dates before the current system date. The software in block 352 then retrieves the information from the system settings table (140), the metadata mapping table (141), the external database table (146), the element of value definition table (155), the component of value definition table (156) and the real option value table (162) as required to initialize sentiment calculation bots for the enterprise.

Bots are independent components of the application that have specific tasks to perform. In the case of sentiment calculation bots, their task is to retrieve data as required from: the external database table (146), the element of value definition table (155), the component of value definition table (156) and the real option value table (162) and then calculate the sentiment for the enterprise in accordance with the formula shown in Table 43.

TABLE 43
Sentiment = Total Market Value − Total Current-Operation Value −
Σ Real Option Values

Every sentiment calculation bot contains the information shown in Table 44.

TABLE 44
1. Unique ID number (based on date, hour, minute, second of creation)
2. Creation date (date, hour, minute, second)
3. Mapping information
4. Storage location
5. Enterprise ID

After the sentiment calculation bots are initialized they activate in accordance with the frequency specified by the user (20) in the system settings table (140). After being activated, the bots retrieve information from the external database table (146), the element of value definition table (155), the component of value definition table (156) and the real option value table (162) as required to complete the sentiment calculation for each enterprise. After the calculation is complete, the resulting values are then saved in the enterprise sentiment table (166) in the application database (50) before processing advances to a block 353.

The software in block 353 checks the bot date table (149) and deactivates any sentiment analysis bots with creation dates before the current system date. The software in block 353 then retrieves the information from the system settings table (140), the metadata mapping table (141), the external database table (146), the element of value definition table (155), the component of value definition table (156), the real option value table (162), the enterprise sentiment table (166) and the market value factors table (169) as required to initialize sentiment analysis bots for the enterprise.

Bots are independent components of the application that have specific tasks to perform. In the case of sentiment analysis bots, their primary task is to determine the composition of the calculated sentiment by comparing the portion of overall market value that is “caused” by different elements of value and the calculated valuation for each element of value as shown below in Table 45.

TABLE 45
Total Enterprise Market Value = $100 Billion,
10% “caused” by Brand factors
Implied Brand Value = $100 Billion × 10% = $10 Billion
Valuation of Brand Element of Value = $6 Billion
Increase/(Decrease) in Enterprise Real Option Values
due to Brand = $1.5 Billion
Industry Option Allocation due to Brand = $1.0 Billion
Brand Sentiment = $10 − $6 − $1.5 − $1.0 = $1.5 Billion

Every sentiment analysis bot contains the information shown in Table 46.

TABLE 46

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Enterprise ID |

After the sentiment analysis bots are initialized, they activate in accordance with the frequency specified by the user (20) in the system settings table (140). After being activated, the bots retrieve information from the system settings table (140), the metadata mapping table (141), the enterprise sentiment table (166) and the sentiment factors table (169) as required to analyze sentiment. The resulting breakdown of sentiment is then saved in the sentiment factors table (169) in the application database (50) before processing advances to a block 401.

### Display and Print Results

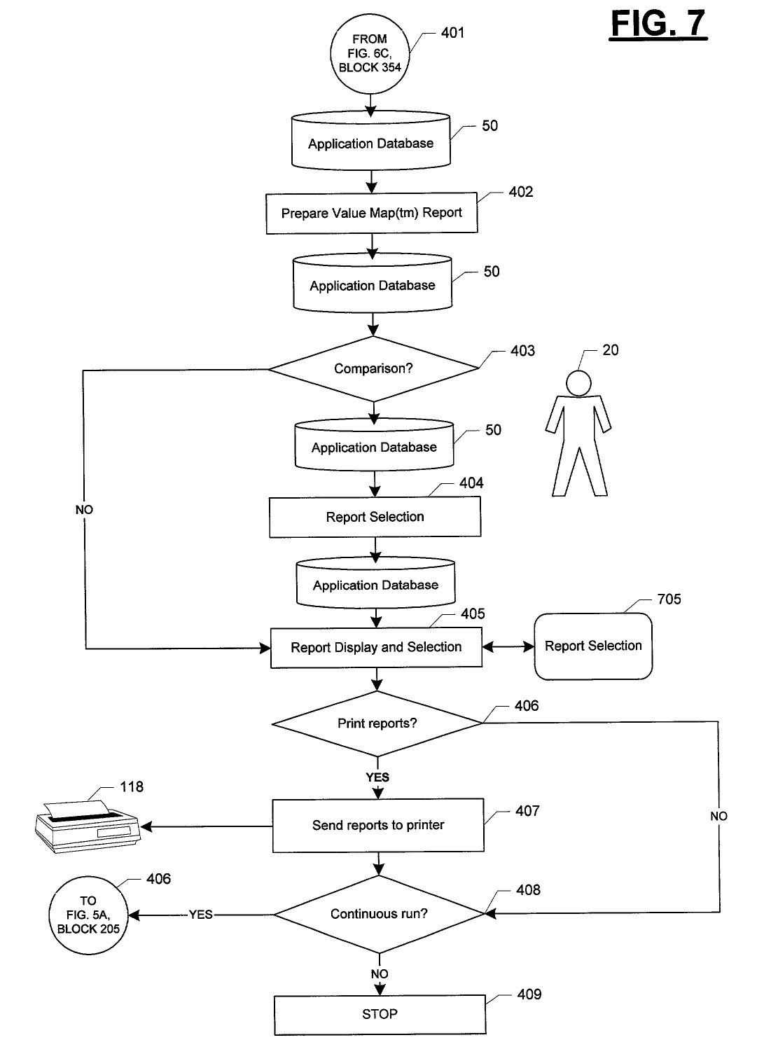

The flow diagram in FIG. 7 details the processing that is completed by the portion of the application software (400) that creates, displays and optionally prints financial management reports. The Value Map® report, summarizes information about the elements and sub-elements of business value on the valuation date. It is the primary output report from the system of the present invention. If a comparison calculation has been completed, a Value Creation Statement can be generated to highlight changes in the elements of value, the sub-elements of business value and the real options during the period between the prior valuation and the current valuation date.

System processing in this portion of the application software (400) begins in block 402. The software in block 402 retrieves the required information, prepares and stores a Value Map® report for enterprise and for the business as a whole. The completed report is stored in the reports table (175) in the application database before processing advances the a block 403.

The software in block 403 checks the system settings table (140) to determine if the current valuation is being compared to a previous valuation. If the current valuation is not being compared to a previous valuation, then processing advances to a software block 405. Alternatively, if the current valuation is being compared to a previously calculated valuation, then processing advances to a software block 404.

The software in block 404 calculates Value Creation Statements for each enterprise and for the business as a whole for the specified time period. After the Value Creation Statements are stored in the reports table (175) in the application database (50), processing advances to a software block 405. The software in block 405 displays the summary Value Map® report to the user (20) via a report selection window (705). After displaying the summary Value Map™ report, the software in block 405 prompts the user via the report selection data window (705) to designate additional reports for display and/or printing. The user (20) has the option of creating, displaying or printing the Value Map® report for the company as a whole and/or for any combination of the enterprises within the company. The user (20) can also choose to display or print a Value Creation Statement for the business as a whole and/or for any combination of enterprises if comparison calculations were completed. The software in block 405 creates and displays all Value Map® reports and Value Creation Statements requested by the user (20) via the report selection data window (705). After the user (20) has completed the review of displayed reports and the input regarding reports to print has been stored in the reports table (175), processing advances to a software block 406.

The software in block 406 checks the reports tables (175) to determine if any reports have been designated for printing. If reports have been designated for printing, then processing advances to a block 407 which sends the designated reports to the printer (118). After the reports have been sent to the printer (118), processing advances to a software block 408. If no reports were designated for printing then processing advances directly from block 406 to 408.

The software in block 408 checks the system settings table (140) to determine if the current calculation is a continuous calculation. If the current valuation is a continuous calculation, then processing returns to software block 205 and the processing described above is repeated. Alternatively, if the current valuation is not a continuous calculation, then processing advances to a software block 409 where processing stops.

Thus, the reader will see that the system and method described above transforms extracted transaction data, corporate information and information from the internet into detailed valuations for real options and specific elements of a business enterprise. The level of detail contained in the business valuations allows users of the system to monitor and manage efforts to improve the value of the business in a manner that is superior to that available to users of traditional accounting systems and business valuation reports. The user also has the option of examining the relationship between the calculated business value and the market price of equity for the business.

While the above description contains many specificity's, these should not be construed as limitations on the scope of the invention, but rather as an exemplification of one preferred embodiment thereof. Accordingly, the scope of the invention should be determined not by the embodiment illustrated, but by the appended claims and their legal equivalents.

1. A computer-implemented method for continuously valuing one or more real options of a business enterprise, comprising:
obtaining data related to the real options, elements of value and value of the business enterprise and its competitors,
determining, which elements of value are causing enterprise stock price changes;
calculating for each causal element of value the relative ranking of each causal element vis a vis firms competing with the enterprise,
calculating the appropriate discount rate for use in valuing the real options and contingent liabilities as a function of the relative causal element strength, and
calculating real option values.

2. The computer-implemented method of claim 1 wherein the value of the business enterprise includes a revenue component, an expense component and a capital component.

3. The computer-implemented method of claim 1 wherein determining which elements of value are causing stock price changes comprises using output from a causal model.

4. The computer-implemented method of claim 1 wherein determining the relative ranking of the causal elements of value comprises using output from a data envelopment analysis to determine the relative ranking of the element of value.

5. The computer-implemented method of claim 1 wherein calculating real option values comprises using a Black Schole's algorithm to complete the calculation.

6. The computer-implemented method of claim 1 wherein calculating real option values comprises using a binomial algorithm to complete the calculation.

7. The computer implemented method of claim 1 where in processing further comprises identifying the variable that is the best predictor of stock price movement by comparing the clustering accuracy based on different variables on the known clustering of the S&P 500.

8. A computer readable medium having sequences of instructions stored therein, which when executed cause a processor to perform a method for continuously valuing one or more real options of a business enterprise, comprising:
obtaining data related to the elements of value, real options and value of the business enterprise and its competitors;
determining, which elements of value are causing enterprise stock price changes;
calculating for each causal element of value the relative ranking of each causal element vis a vis firms competing with the enterprise,
calculating the appropriate discount rate for use in valuing the real options and contingent liabilities as a function of the relative causal element strength, and calculating real option values.

9. The computer readable medium of claim 8, wherein the value of the business enterprise includes a revenue component, an expense component and a capital component.

10. The computer readable medium of claim 8 wherein determining which element variables are causing stock price changes comprises using output from a causal model.

11. The computer readable medium of claim 8 wherein determining the relative ranking of the causal elements of value comprises using output from a data envelopment analysis to determine the relative ranking of each of the causal elements of value.

12. The computer readable medium of claim 8 wherein calculating real option values comprises using a Black Schole's algorithm to complete the calculation.

13. The computer readable medium of claim 8 wherein calculating real option values comprises using a binomial algorithm to complete the calculation.

14. The computer readable medium of claim 8 wherein processing further comprises identifying the variable that is the best predictor of stock price movement by comparing the clustering accuracy based on different variables on the known clustering of the S&P 500.

15. A computer sys tem, comprising:
a processor having circuitry to execute instructions;
a storage device coupled to the processor and having sequences of instructions stored therein, which when executed cause the processor to,
obtain data related to the elements of value, real options and value of the business enterprise and its competitors;
determine, which elements of value are causing enterprise stock price changes;
calculate for each causal element of value the relative ranking of each causal element vis a vis firms competing with the enterprise,
calculate the appropriate discount rate for use in valuing the real options and contingent liabilities as a function of the relative causal element strength, and calculate real option values.

16. The computer system of claim 15, wherein the processor is further caused to determine which elements of value are causing stock price changes comprises using output from a causal model.

17. The computer system of claim 15 wherein determining the relative ranking of the causal elements of value comprises using output from a data envelopment analysis to determine the relative ranking of each of the causal elements of value.

18. The computer system of claim 15 wherein calculating the value the real options comprises using a Black Schole's algorithm to complete the calculation.

19. The computer system method of claim 15 wherein calculating the value of the real option comprises using a binomial algorithm to complete the calculation.

20. The computer system method of claim 15 wherein calculating the value of the real option further comprises identifying the variable that is the best predictor of stock price movement by comparing the clustering accuracy based on different variables on the known clustering of the S&P 500.

21. A computer-implemented method for continuously valuing the elements of value of a business enterprise, comprising:
obtaining data relative to the value of the enterprise and its competitors,
identifying causal value drivers by element of value,
determining the relative impact of causal value drivers on the current operation cash flow of the enterprise by element of value,
determine the elements of value that are causal to stock price movement,
determining the value impact of causal elements of value on the real options of the enterprise, and
calculating the value of the element of value by adding the impact of the element of value on the real options of the enterprise with the product of the relative impact of the element of value on current operation cash flow and the enterprise current operation cash flow.

22. The computer-implemented method of claim 21 wherein valuing the elements of value for the enterprise further comprises calculating for each causal element of value the relative ranking of each causal element vis a vis firms competing with the enterprise and calculating the appropriate discount rate for use in valuing the real options as a function of the relative causal element strength using data envelopment analysis.

23. The computer-implemented method of claim 21 wherein the value drivers identified by predictive models have been determined to be causal drivers by a causal model.

24. The computer-implemented method of claim 21 wherein determining the percentage of the cash flow, attributable to each causal value driver comprises using output from a predictive model to determine the percentage of the cash flow attributable to the value driver.

25. The computer-implemented method of claim 21 wherein the value driver comprises one or more item variables, one or more composite variables and/or one or more item performance indicators.

26. A computer readable medium having sequences of instructions stored therein, which when executed cause a processor to perform a method for continuously valuing the elements of value of a business enterprise, comprising:
obtaining data relative to the value of the enterprise and its competitors,
identifying causal value drivers by element of value,
determining the relative impact of causal value drivers on the current operation cash flow of the enterprise by element of value,
identifying causal elements of value for stock price movement,
determining the value impact of causal elements of value on the real options of the enterprise, and
calculating the value of the element of value by adding the product of the relative impact of the element of value on current operation cash flow and the forecast enterprise cash flow with the impact of the element of value on the real options of the enterprise

27. The computer readable medium of claim 26 wherein valuing the elements of value for the enterprise further comprises calculating for each causal element of value the relative ranking of each causal element vis a vis firms competing with the enterprise and calculating the appropriate discount rate for use in valuing the real options as a function of the relative causal element strength using data envelopment analysis.

28. The computer readable medium of claim 26 wherein the value drivers identified by predictive models have been determined to be causal drivers by a causal model.

29. The computer readable medium of claim 26 wherein determining the percentage of the cash flow, attributable to each causal value driver comprises using output from a predictive model to determine the percentage of the cash flow attributable to the value driver.

30. The computer readable medium of claim 26 wherein the value driver comprises one or more item variables, one or more composite variables and/or one or more item performance indicators.

31. A computer system, comprising:
a processor having circuitry to execute instructions;
a storage device coupled to the processor and having sequences of instructions stored therein, which when executed cause the processor to,
obtain data relative to the value of the enterprise and its competitors,
identify causal value drivers by element of value,
determine the relative impact of causal value drivers on the current operation cash flow of the enterprise by element of value,
identify causal elements of value for stock price movement,
determine the value impact of causal elements of value on the real options of the enterprise, and
calculate the value of the element of value by adding the product of the relative impact of the element of value on current operation cash flow and the forecast enterprise cash flow with the impact of the element of value on the real options of the enterprise

32. The computer system of claim 31 wherein valuing the elements of value for the enterprise further comprises calculating for each causal element of value the relative ranking of each causal element vis a vis firms competing with the enterprise and calculating the appropriate discount rate for use in valuing the real options as a function of the relative causal element strength using data envelopment analysis.

33. The computer system of claim 31 wherein the value drivers identified by predictive models have been determined to be causal drivers by a causal model.

34. The computer system of claim 31 wherein determining the percentage of the cash flow, attributable to each causal value driver comprises using output from a predictive model to determine the percentage of the cash flow attributable to the value driver.

35. The computer system of claim 31 wherein the value driver comprises one or more item variables, one or more composite variables and/or one or more item performance indicators.
